(19) United States
(12) Patent Application Publication
(10) Pub. No.: US 2024/0186037 A1
(43) Pub. Date: Jun. 6, 2024

(54) MAGNETIC MATERIAL FOR HIGH FREQUENCY USE, AND METHOD FOR PRODUCING SAME

(71) Applicant: National Institute of Advanced Industrial Science and Technology, Chiyoda-ku, Tokyo (JP)

(72) Inventors: Nobuyoshi IMAOKA, Nagoya (JP); Kimihiro OZAKI, Nagoya (JP); Tatsuya KON, Nagoya (JP)

(73) Assignee: National Institute of Advanced Industrial Science and Technology, Chiyoda-ku, Tokyo (JP)

(21) Appl. No.: 18/277,339

(22) PCT Filed: Mar. 22, 2022
(86) PCT No.: PCT/JP2022/012999

§ 371 Date: Aug. 15, 2023

(30) Foreign Application Priority Data
Mar. 25, 2021 (JP) 2021-052020

(51) Int. Cl. H01F 1/059

(52) U.S. Cl. CPC H01F 1/059

(57) ABSTRACT

The present invention addresses the problem of providing: a novel magnetic material for high frequency use, the magnetic material solving problems such as eddy current loss since the magnetic material has higher electrical resistivity than metal magnetic materials, while having higher magnetic permeability than ferrite magnetic materials; and a method for producing this magnetic material for high frequency use.

The present invention uses a rare earth-iron-M-nitrogen magnetic material (wherein M represents at least one element that is selected from among Ti, V, Mo, Nb, W, Si, Al, Mn and Cr) which is a nitride magnetic material that has a controlled crystal structure and a controlled composition.

### TECHNICAL FIELD

The present invention relates to a magnetic material used in a high frequency region of 0.001 GHz or more and 100 GHz or less (that is, the high-frequency magnetic material) and a method for producing the same.

The present invention also relates to a high-frequency magnetic material used by making the high-frequency magnetic material with another material (for example, a nonmagnetic ceramic material and/or a resin) composite. Particularly, the present invention relates to a high-frequency magnetic material containing a resin and a method for producing the same.

### BACKGROUND ART

As for the above magnetic material, examples of the magnetic material for the power device and the information communication-related device include the following: magnetic materials for transformers, heads, inductors, reactors, yokes, cores (magnetic cores), and the like; magnetic materials for antennas, microwave elements, magnetostrictive elements, magnetoacoustic elements, and magnetic recording elements, and the like; and magnetic materials for Hall sensors (Hall elements), magnetic sensors, current sensors, rotation sensors, and sensors using a magnetic field such as an electronic compass. In particular, magnetic materials for a coil core and an antenna core used in a wireless power feeding (which is also referred to as wireless power transmission or contactless power transmission) system are included.

As for the above magnetic material, examples of the magnetic material for suppressing interference due to unnecessary electromagnetic wave interference include the following: magnetic materials for electromagnetic noise absorption, electromagnetic wave absorption, magnetic shielding, and the like; magnetic materials for inductor elements such as noise removing inductors; magnetic materials for RFID (Radio Frequency Identification) tags; and magnetic materials for noise filter that remove noise from signals at the high frequency.

Recently, as various information communication devices such as personal computers, mobile phones, and digital cameras, which are mobile information communication devices, become more compact, more multi-functional, and faster in operation processing speed, higher drive frequencies have been rapidly developed, and devices using the high frequency of a frequency of 0.001 GHz or more and 100 GHz or less, in particular, ultra-high frequency of 1 GHz or more, have been steadily spreading. In recent years, the demand for devices such as satellite communication, mobile communication, and car navigation using electromagnetic waves in a microwave band has been greatly increased, and for example, a technology such as an automobile toll collection system (ETC), a short-range wireless communication such as a wireless LAN, and an in-vehicle millimeter wave radar such as a collision prevention radar have started to spread. In addition, in the field of wireless power supply systems, the high frequency is in progress. Low-frequency charging for home appliances such as mobile phones and automatic vacuum cleaners has become widespread, and low frequency charging of electric vehicles and the like that are stopped has also been put into practical use. However, recently, a demonstration test of high frequency power feeding and the like to next-generation vehicles and the like that are moving has been performed, and high-power wireless power feeding and the like from power plants by microwaves have been studied. As the flow of use of high frequency as described above, in particular, ultra-high frequency proceeds, there is a strong demand for a magnetic material capable of coping with an electromagnetic field change of a high frequency without loss.

On the other hand, the deterioration of the electromagnetic environment (specifically, electromagnetic interference with another device or a living body) due to the electromagnetic wave emitted from these high frequency devices to the outside is regarded as a problem, and the movement of legal regulations and voluntary regulations by public organizations and international organizations is currently activated. As described above, a signal (an electromagnetic wave) useful in individual device may become an obstacle for another device and a living body, and thus it is very difficult to cope with this problem. In order to solve the problem, as properties of the device, it is important not to emit an unnecessary electromagnetic wave (electromagnetic noise) and to have strong resistance to an external noise, that is, it is important to establish electromagnetic compatibility (EMC: Electro-Magnetic Compatibility) in which both electromagnetic interference (EMI: Electro-Magnetic Interference) and damage (EMS: Electro-Magnetic Susceptibility) are considered.

As an example of the EMC countermeasure, an electromagnetic noise absorbing material that has been often used in electronic devices recently is mainly described below.

The electromagnetic noise absorbing material is a material having a function of suppressing emission of an electromagnetic wave to the outside in the vicinity of the electromagnetic noise source. In a high frequency region of several hundred MHz or more, a sheet-like electromagnetic noise absorbing material is often used which absorbs a high frequency electromagnetic noise such as a harmonic wave transmitted on a line using natural resonance of Ni—Zn ferrite or the like and converts the electromagnetic noise into thermal energy to suppress the noise. There are two required magnetic properties: a high relative permeability of the magnetic material and a high natural resonance frequency. Since ferrite, which is an oxide magnetic material, has high electric resistivity, performance degradation due to eddy current loss is small, and ferrite has been a preferable material for use in a high frequency region.

On the other hand, as described in PATENT LITERATURE 1, since the value of the imaginary term of the permeability of ferrite in the ultra-high frequency region is about 1 to 2 or less, it is difficult to apply the ferrite oxide magnetic material to an electromagnetic noise absorbing material in the GHz band (region). Therefore, in recent years, use of a metal-based magnetic material such as Fe, an Fe—Ni-based alloy, an Fe—Ni—Si-based alloy, sendust, an Fe—Cu—Nb—Si-based alloy, or an amorphous alloy having a larger saturation magnetization value than that of a ferrite oxide magnetic material has become active, and a magnetic material in which magnetic metal fine particles are dispersed in a resin having insulation properties or the like has been developed as an electromagnetic noise absorbing material.

### CITATION LIST

### Patent Literature

PATENT LITERATURE 1: WO 2008/136391 A

### SUMMARY OF INVENTION

### Technical Problems

However, the electric resistivity of the metal-based magnetic material is 10 to 140 μΩcm, which is considerably lower compared with the electric resistivity of ferrite of 4000 to 10¹⁸ μΩcm. Therefore, high permeability cannot be achieved up to high frequencies, and it is difficult to use the electric resistivity of the metal-based magnetic material in a high frequency region. This is because an insulating layer is required in order to prevent the permeability from starting to decrease from a low frequency region due to eddy current loss, and thus the nonmagnetic portion lowers the complex relative permeability in the high frequency region of the original magnetic material-resin composite material. Furthermore, in the ultra-high frequency region exceeding 1 GHz, even in such a composite material, a decrease in permeability due to the influence of eddy current loss is inevitable.

In addition, a metal-based magnetic substance to which shape anisotropy is imparted has also been developed, but basically, according to the same consideration as in PATENT LITERATURE 1, it is necessary to make the thickness of the metal-based magnetic substance filler less than 0.2 μm, and even if the packing factor is increased to some extent and the permeability is increased thereby, the application to ultra-high frequency applications is limited.

For this reason, there has been a strong demand for the development of a magnetic material for an electromagnetic noise absorbing material having a higher permeability and more excellent electromagnetic noise suppression performance in a high frequency region (particularly in an ultra-high frequency region), and an electromagnetic noise absorbing material (for example, a magnetic material that can be dispersed in a resin to form a sheet) of which mass production is easy and has a wide application range adaptable to applications requiring flexibility.

For this reason, it is important for an excellent high-frequency magnetic material that the value of the real term of its complex relative permeability does not decrease and the value of its imaginary term does not increase up to a high frequency region (if necessary, an ultra-high frequency region), even when being used as the following: high frequency absorbing materials for suppressing and absorbing spurious and electromagnetic noise in electromagnetic noise absorbing materials; materials for high-frequency cores (magnetic cores) and for RFID tags; and high frequency amplifying materials for generating a magnetic field or electromagnetic field amplified in proportion to the magnetic field or electromagnetic wave of the operating frequency, such as the core of the coil for the wireless power supply system.

In addition, when being used as a high frequency absorbing material, it is important for an excellent high-frequency magnetic material that the value of the imaginary term of its complex relative permeability is sufficiently large at a desired frequency at which unnecessary radiation, harmonics, and the like exist by increasing with the frequency even if the value of the imaginary term of its complex relative permeability in a high frequency region (ultra-high frequency region as necessary) is close to 0 in a low frequency region.

Furthermore, in order to amplify the magnitude of a signal in an RFID tag for a high frequency signal, a core of a coil for a wireless power supply system, or the like, it is important to achieve a real term of high permeability in a frequency region where the signal exists. However, depending on the uses, it can be necessary to absorb and remove noise like harmonics from a high frequency to an ultra-high frequency region without absorbing a signal on a frequency side lower than a certain frequency at the same time. In particular, a material having a value of an imaginary term (μ″) of complex relative permeability close to 0 in a frequency region lower than 1 GHz of a boundary and having a value of a large imaginary term (μ″) in a high frequency region (that is, the ultra-high frequency region) is sometimes required (note that a material having a larger “selective absorption ratio of 1 GHz or more” defined below is a material more suitable for the above purpose).

However, conventionally, as far as the present inventors know, only the oxide magnetic material and the metal-based magnetic material described above are used as the magnetic material for high frequency use. As described above, even if the oxide magnetic material (in particular, a ferrite oxide magnetic material having a high electric resistivity) is used, there is a problem that a sufficient permeability cannot be obtained even if the problem due to the eddy current loss is small, and even if the metal-based magnetic material is used, there is a problem that the eddy current loss occurs in a low frequency region because the permeability is high but the electric resistivity is small, and there is a problem that both of them are not suitable as magnetic materials for applications for high frequency use.

PATENT LITERATURE 1 attempts to solve this problem caused by using a nitride material, but the material disclosed in PATENT LITERATURE 1 cannot exhibit sufficient performance as, for example, an electromagnetic wave absorbing material having high permeability in an ultra-high frequency region or a magnetic field amplifying material used in a high frequency region of 0.001 GHz or more and 0.1 GHz or less.

In such circumstances, there is a current situation in which development of a new magnetic material capable of exerting higher performance than before even in a high frequency region of 0.001 GHz or more and 100 GHz or less is desired as a high-frequency magnetic material.

The present invention has been made in view of the above problems, and it is an object of the present invention to provide a new high-frequency magnetic material using, as a magnetic material in high frequency uses, a nitride-based magnetic material, specifically, a rare earth-iron-M-nitrogen-based magnetic material (wherein the M is at least one element selected from the group consisting of Ti, V, Mo, Nb, W, Si, Al, Mn, and Cr.) of which a crystal structure and a particle diameter are controlled, thereby making it possible to achieve a high permeability because of its higher magnetization than that of an oxide magnetic material and to solve the above-described problems, for example the problem of eddy current loss because of its higher electric resistivity than that of a metal material.

In addition, an object of the present invention is to provide, by making a resin or a ceramic material with the above rare earth-iron-M-nitrogen-based magnetic material of which a crystal structure and a particle diameter are controlled composite, a novel nitride-based magnetic material capable of further increasing the electric resistivity of the rare earth-iron-M-nitrogen-based magnetic material and more effectively solving the problems of the eddy current loss and so on, wherein the nitride-based magnetic material has high performance (specifically, high permeability) as a high-frequency composite magnetic material.

Another object of the present invention is to provide a magnetic material for electromagnetic field amplification and electromagnetic field absorption used in a high frequency region of 0.001 GHz or more and 100 GHz or less, particularly a magnetic field amplifying material used in a high frequency region of 0.001 GHz or more and 0.1 GHz or less.

The “high-frequency magnetic material” in the present application is a magnetic material that functions as a magnetic material used in a high frequency region (so-called high-frequency magnetic material). Therefore, the “high-frequency magnetic material” in the present application includes two or more different kinds of magnetic materials, or a magnetic material obtained by making one or more kinds of magnetic materials and a nonmagnetic material (for example, a nonmagnetic ceramic material and/or a resin) composite, which functions as a magnetic material used in a high frequency region (so-called high-frequency magnetic material). In the present application, such a magnetic material may be referred to as a “high-frequency composite magnetic material”. In the present application, the term “composite” means a state in which a region occupied by a magnetic material is, in the case where the magnetic material is composed of two or more different kinds of magnetic materials, divided or covered with the different magnetic materials, and a region occupied by a magnetic material is, in the case where the magnetic material is composed of one or more kinds of magnetic materials and a nonmagnetic material, divided or covered with the nonmagnetic material.

In addition, among the “high-frequency composite magnetic materials”, a material including a resin, for example, a magnetic material functioning as a magnetic material (so-called high-frequency magnetic material) used in a high frequency region by a composite of one or more kinds of magnetic materials and a resin or a composite of one or more kinds of magnetic materials, a ceramic material, and a resin can be sometimes referred to as a “high-frequency resin composite magnetic material” in the present application.

As described above, both the above “high-frequency composite magnetic material” and the above “high-frequency resin composite magnetic material” function as high-frequency magnetic materials, and thus are “high-frequency magnetic materials” in a broad sense. Therefore, the “high-frequency magnetic material” in the present application includes both the above “high-frequency composite magnetic material” and the above “high-frequency resin composite magnetic material”.

In addition, in the present application, a magnetic material obtained by making two or more different kinds of magnetic materials composite or by making one or more kinds of magnetic materials and a nonmagnetic material (for example, a nonmagnetic ceramic material and/or a resin) composite can be sometimes referred to as a “composite magnetic material” simply, and the composite magnetic material including a resin among them can be sometimes referred to as a “resin composite magnetic material” simply.

In the present application, an electromagnetic wave having a frequency of 0.001 GHz or more and 100 GHz or less is referred to as a “high frequency”, and the “ultra-high frequency” therein means a high frequency of 1 GHz or more. In the present application, “ultra-high frequency” is also included in “high frequency” unless otherwise specified. Therefore, in the present application, the “high frequency region” refers to an electromagnetic wave region having a frequency of 0.001 GHz or more and 100 GHz or less, and an electromagnetic wave region having a frequency of 1 GHz or more in the electromagnetic wave region among them refers to an “ultra-high frequency region”.

In the present application, an electromagnetic wave having a frequency lower than the above “high frequency” is referred to as a “low frequency” unless otherwise specified.

Furthermore, the “high-frequency magnetic material” in the present application is a magnetic material that acts on an electric field, a magnetic field, or an electromagnetic field in a frequency region of 0.001 GHz or more and 100 GHz or less to achieve a “target function”, and the “high-frequency composite magnetic material” is included therein. Here, the “target function” refers to magnetic functions of a magnetic material of electromagnetic induction, self-induction, high permeability, high frequency loss, magnetostriction, magnetic domain formation, semi-hard magnetism, and so on, and the “high-frequency composite magnetic material” of the present invention is used in an element, a component, an apparatus, or the like using these functions. In the present application, among them, a magnetic material having, as a target function, high permeability such as a magnetic field amplifying material used in a high frequency region can be sometimes referred to as a “high frequency amplifying material”, and a magnetic material having, as a target function, high frequency loss can be sometimes referred to as a “high frequency absorbing material”.

### Solution to Problems

The present inventors have intensively studied a high-frequency magnetic material having excellent electromagnetic properties and also having contradictory properties in a conventional magnetic material (specifically, a high-frequency magnetic material having high permeability and high electric resistivity, which can solve the above-described problem of eddy current loss, and having excellent electromagnetic properties with advantages of both a metal-based magnetic material and an oxide magnetic material). As a result, the present inventors have found that a high-frequency magnetic material having extremely high electromagnetic properties capable of solving the above problems can be obtained by using a rare earth-iron-M-nitrogen-based magnetic material (wherein the M is at least one element selected from the group consisting of Ti, V, Mo, Nb, W, Si, Al, Mn, and Cr) as a high-frequency magnetic material, adjusting the composition, crystal structure, and particle diameter of the rare earth-iron-M-nitrogen-based magnetic material, and adjusting the blending with a ceramics, a resin, or another magnetic material, and have further established a production method thereof, thereby completing the present invention.

The present invention is specifically as follows.

(1) A high-frequency magnetic material, the magnetic material comprising: a main phase has a composition represented by a general formula represented by the following formula 1:

RₓFe_{(100-x-y-z)}M_{y}N_{z} (formula 1)
wherein the R is at least one element selected from the group consisting of rare earth elements including Y, the Fe is an iron element, the M is at least one element selected from the group consisting of Ti, V, Mo, Nb, W, Si, Al, Mn, and Cr, the N is a nitrogen element, and each value of the x, y, and z satisfies 2 atom %≤x≤15 atom %, 0.5 atom %≤y≤25 atom %, and 3 atom %≤z≤50 atom %, and
wherein the high-frequency magnetic material is used in a frequency region of 0.001 GHz or more and 100 GHz or less.

(2) The high-frequency magnetic material according to (1), wherein Fe in the formula 1 is substituted with Co or a Ni element in an amount of 50 atom % or less.

(3) The high-frequency magnetic material according to (1) or (2), wherein R in the formula 1 contains Sm element in an amount of 50 atom % or more.

(4) The high-frequency magnetic material according to any one of (1) to (3), wherein a crystal structure of the main phase is a tetragonal.

(5) The high-frequency magnetic material according to any one of (1) to (4), wherein the magnetocrystalline anisotropy is in-plane magnetic anisotropy.

(6) The high-frequency magnetic material according to (1) or (2), wherein a crystal structure of the main phase is amorphous.

(7) The high-frequency magnetic material according to any one of (1) to (6), wherein less than 50 atom % of N in the formula 1 is substituted with at least one element selected from the group consisting of H, C, P, Si, and S.

(8) The high-frequency magnetic material according to any one of (1) to (7), wherein the magnetic material is a powder having an average particle diameter of 0.1 μm or more and 2000 μm or less.

(9) A high-frequency magnetic material comprising:
1% by mass or more and 99.999% by mass or less of the high-frequency magnetic material according to any one of (1) to (8); and
0.001% by mass or more and 99% by mass or less of at least one selected from the group consisting of a metal Fe, a metal Ni, a metal Co, an Fe—Ni-based alloy, an Fe—Ni—Si-based alloy, a sendust, an Fe—Si—Al-based alloy, an Fe—Cu—Nb—Si-based alloy, an amorphous alloy, magnetite, Ni-ferrite, Zn-ferrite, Mn—Zn ferrite, and Ni—Zn ferrite.

(10) The high-frequency magnetic material according to (9), wherein the metal Fe is a carbonyl iron powder.

(11) A high-frequency magnetic material comprising:
1% by mass or more and 99.999% by mass or less of the high-frequency magnetic material according to any one of (1) to (10); and
0.001% by mass or more and 99% by mass or less of a ceramic material.

(12) A high-frequency magnetic material comprising:
5% by mass or more and 99.9% by mass or less of the high-frequency magnetic material according to any one of (1) to (11); and
0.1% by mass or more and 95% by mass or less of a resin.

(13) The high-frequency magnetic material according to (12), wherein the resin comprises a segment having a solubility parameter of 10 or more and 15 or less.

(14) The high-frequency magnetic material according to any one of (1) to (13), wherein the high-frequency magnetic material is magnetically oriented.

(15) A method for producing the high-frequency magnetic material according to (1), the method comprising heat-treating an alloy containing, as main components, R, Fe, and M in the formula 1 at a temperature in a range of 100° C. or more and 600° C. or less under a nitrogen atmosphere containing an ammonia gas.

(16) A method for producing the high-frequency magnetic material according to (12), the method comprising the steps of: kneading the high-frequency magnetic material according to (1) produced by the method according to (15) with a resin containing a segment having a solubility parameter of 10 or more and 15 or less; and performing a compression molding, an injection molding, and/or a calendering molding.

### Advantageous Effects of Invention

According to the present invention, a new magnetic material that can be used in all high frequency regions from 0.001 GHz to 100 GHz as a high-frequency magnetic material can be provided.

According to the present invention, for example, a high-frequency magnetic material having high permeability and small eddy current loss, particularly a high-frequency magnetic material suitable for a high-frequency composite magnetic material that functions as an electromagnetic wave absorber in an ultra-high frequency region (particularly, an ultra-high frequency region of 1 GHz or more) or that functions as a high frequency amplifying material in a high frequency region (particularly, a high frequency region of 0.1 GHz or less) can be provided.

### BRIEF DESCRIPTION OF THE DRAWINGS

FIG. 1 is an X-ray diffraction diagram (Co-Kα radiation source) of a Sm_{6.4}Fe_{70.5}Ti_{6.4}N_{16.7} magnetic powder (“Example 1”) and a Sm_{7.7}Fe_{84.6}Ti_{7.7} raw material alloy powder (“Comparative Example 1”).

FIG. 2 is a diagram showing frequency changes in complex relative permeability of a high-frequency magnetic material powder (“Example 2”) obtained by finely pulverizing a Sm_{6.4}Fe_{70.5}Ti_{6.4}N_{16.7} magnetic powder and a Sm_{7.7}Fe_{84.6}Ti_{7.7} raw material alloy powder (“Comparative Example 1”).

FIG. 3 is a diagram showing a frequency change in complex relative permeability of a Sm_{7.2}Fe_{72.4}V_{14.5}N_{5.9}-based magnetic material (“Example 3”).

FIG. 4 is a scanning electron microscope (SEM) photograph of a cross section of a Ce_{7.7}Fe_{84.6}Ti_{7.7} raw material alloy before and after annealing. “A” indicates the raw material alloy before annealing, and “B” indicates the raw material alloy after annealing. In the drawing, a black region is a Fe—Ti alloy phase, a gray region is a CeFe₁₁Ti alloy phase, and a white region is a Ce-enriched phase such as a Ce₂Fe₁₇ alloy phase.

FIG. 5 is an X-ray diffraction diagram (Co-Kα radiation source) of a Ce_{5.3}Fe_{55.2}Ti_{5.3}N_{31.2} magnetic powder (“Example 4”) and a Ce_{7.7}Fe_{84.6}Ti_{7.7} raw material alloy powder (“Comparative Example 2”).

FIG. 6 is a diagram showing frequency changes in complex relative permeability of a Ce_{5.3}Fe_{55.2}Ti_{5.3}N_{31.2} magnetic powder (“Example 4”) and a Ce_{7.7}Fe_{84.6}Ti_{7.7} raw material alloy powder (“Comparative Example 2”).

### DESCRIPTION OF EMBODIMENTS

Hereinafter, the present invention is described in detail.

The “high-frequency magnetic material” of the present invention includes a main phase having a composition represented by a general formula represented by the following formula 1, that is,

RₓFe_{(100-x-y-z)}M_{y}N_{z} (formula 1)
(wherein the R is at least one element selected from the group consisting of rare earth elements including Y, the Fe is an iron element, the M is at least one element selected from the group consisting of Ti, V, Mo, Nb, W, Si, Al, Mn, and Cr, the N is a nitrogen element, and each value of the x, y, and z satisfies 2 atom %≤x≤15 atom %, 0.5≤y≤25 atom %, and 3≤z≤50 atom %), and
wherein the high-frequency magnetic material is used in a frequency region of 0.001 GHz or more and 100 GHz or less.

That is, the “high-frequency magnetic material” of the present invention uses a “rare earth-iron-M-nitrogen-based magnetic material” (wherein, the rare earth means at least one element selected from the group consisting of rare earth elements including Y, the Fe means an iron element, the M means at least one element selected from the group consisting of Ti, V, Mo, Nb, W, Si, Al, Mn, and Cr, and the nitrogen means a nitrogen element.). In the “high-frequency magnetic material” of the present invention, the composition of the main phase of the “rare earth-iron-M-nitrogen-based magnetic material” satisfies the above formula 1.

The main form of the “high-frequency magnetic material” of the present invention (that is, a “rare earth-iron-M-nitrogen-based magnetic material” (wherein the rare earth means at least one element selected from the group consisting of rare earth elements including Y, the Fe means iron element, the M means at least one element selected from the group consisting of Ti, V, Mo, Nb, W, Si, Al, Mn, and Cr, and the nitrogen means nitrogen element), wherein the composition of the main phase of the rare earth-iron-M-nitrogen-based magnetic material satisfies the above formula 1) is a powder, and in the present application, this may be referred to as “high-frequency magnetic material powder”.

The high-frequency magnetic material powder is molded by adjusting the composition and particle diameter thereof and adding components such as ceramics and resins thereto as necessary, and then used in various uses as a high-frequency composite magnetic material. In the high-frequency composite magnetic material, ferromagnetism is mainly performed by a rare earth-iron-M-nitrogen-based magnetic material component, but when a ceramic material or a resin coexists between the material powder particles, a significant improvement in electric resistivity is achieved. In addition, by introducing and adjusting a nanoceramic material and a resin having a polarity with a solubility parameter of 10 or more and 15 or less, the isolated dispersion of the rare earth-iron-M-nitrogen-based magnetic material powder, which is a high-frequency magnetic material powder, is promoted, and thus a significant improvement in electric resistivity is achieved. In the present application, “nano” means a scale of 1 nm or more and less than 1000 nm unless otherwise specified.

When these high-frequency composite magnetic materials are used, an electromagnetic wave absorbing material used in a high frequency region of 0.001 GHz or more and 100 GHz or less and a high frequency amplifying material used in a high frequency region of 0.001 GHz or more and 0.1 GHz or less, in which an eddy current loss is significantly reduced, can be obtained.

Hereinafter, the composition of the “rare earth-iron-M-nitrogen-based magnetic material” used as the “high-frequency magnetic material” of the present invention, and the crystal structure, form, and magnetic anisotropy thereof are described. In addition, methods for producing these materials (in particular, a method for nitriding a rare earth-iron-M-based raw material alloy in order to obtain a rare earth-iron-M-nitrogen-based magnetic material) are also described.

As described above, the “high-frequency magnetic material” of the present invention is a “rare earth-iron-M-nitrogen-based magnetic material” (wherein the rare earth means at least one element selected from the group consisting of rare earth elements including Y, the Fe means an iron element, the M means at least one element selected from the group consisting of Ti, V, Mo, Nb, W, Si, Al, Mn, and Cr, and the nitrogen means a nitrogen element).

The composition of the main phase of the “rare earth-iron-M-nitrogen-based magnetic material” used as the “high-frequency magnetic material” of the present invention is specifically represented by the general formula described in the above formula 1, but the rare earth element (i.e., “R”) in the above formula 1 may include at least one element selected from the group consisting of the following rare earth elements: Y, La, Ce, Pr, Nd, Pm, Sm, Eu, Gd, Tb, Dy, Ho, Er, Tm, Yb, and Lu. Therefore, a raw material obtained by mixing two or more rare earth elements like misch metal and didymium may be used, but a preferable rare earth element is at least one element selected from the group consisting of Sm, Y, Ce, La, Pr, Nd, Gd, Dy, Er, and Yb. More preferable rare earth element is at least one element selected from the group consisting of Sm, Y, and Ce.

It is more preferable that at least one of Sm, Y, and Ce is contained in an amount of 50 atom % or more with regard to the entire “R” component because a material having permeability or “maximum absorbed energy coefficient” defined as described later of more than 2 GHz, or a material having a remarkably high value of more than 5 GHz can be obtained, and it is particularly preferable that Sm is contained in an amount of 50 atom % or more from the viewpoint of a balance between oxidation resistance performance and cost.

The crystal structure of the main phase of the “rare earth-iron-M-nitrogen-based magnetic material” used as the “high-frequency magnetic material” of the present invention is preferably at least one selected from tetragonal, hexagonal, rhombohedral crystal, and amorphous state, and more preferably tetragonal or amorphous state.

In the rare earth-iron-M-nitrogen-based magnetic material having at least one crystal structure selected from tetragonal, hexagonal, rhombohedral crystal, and amorphous state (in particular, tetragonal crystal or amorphous state) (hereinafter, this material is also referred to as “R—Fe-M-N-based magnetic material”, and this “R” is also referred to as “rare earth component” or “R component”.), in view of one of the objects of the present invention to actively utilize in-plane magnetic anisotropy, the content of Sm, Y, or Ce in the rare earth component is preferably 50 atom % or more in the rare earth component. The reasons are as follows: in the rare earth-iron-M-nitrogen-based magnetic material having a tetragonal crystal structure, when the rare earth component is Sm, the uniaxial anisotropy constant Kᵤ becomes negative at room temperature or higher, and thus the magnetocrystalline anisotropy becomes an in-plane material and in other Pr, Nd, Gd, Tb, Dy, Ho, Er, Tm, Lu, and the like, each uniaxial anisotropy constant Kᵤ of them becomes positive at room temperature or higher; and therefore these magnetocrystalline anisotropies tend to become a uniaxial material. The magnetocrystalline anisotropy of the amorphous rare earth-iron-M-nitrogen-based magnetic material of the present invention is substantially isotropic, and is suitably used as a high frequency amplifying material such as a magnetic field amplifying material used in a range of 0.001 GHz or more and 0.1 GHz or less.

The rare earth element used here has only to have a purity that can be obtained by industrial production, and impurities that cannot be avoided in its production, such as O, H, C, Al, Si, F, Na, Mg, Ca, and Li, may be present.

The rare earth component (i.e., R component) content in the “rare earth-iron-M-nitrogen-based magnetic material (i.e., R—Fe-M-N-based magnetic material)” used as the “high-frequency magnetic material” of the present invention is preferably 2 atom % or more and 15 atom % or less in the magnetic material composition. Setting the R component to 2 atom % or more is more preferable in order to avoid the following problems: if the content is less than the above content, the soft magnetic metal phase containing a large amount of an iron component is separated beyond a permissible amount even after casting and annealing of the mother alloy, and such a kind of soft magnetic metal phase has a “maximum absorption frequency” defined below in a low frequency region, so that the permeability is reduced, and the function as a high-frequency magnetic material in a high frequency region (in particular, in the ultra-high frequency region), which is one of the objects of the present invention, is impaired.

In addition, setting the R component content to 15 atom % or less is preferable in terms of avoiding the problem that the permeability and magnetization decrease if the R component content exceeds the above value. The composition range of the R component is more preferably 5 atom % or more and 10 atom % or less.

Iron (Fe) is a basic component of a “rare earth-iron-M-nitrogen-based magnetic material (R—Fe-M-N-based magnetic material)” that is responsible for ferromagnetism in the present invention, and the content thereof is preferably 10 atom % or more in the magnetic material composition. The content of the iron component (Fe component) is preferably 10 atom % or more in terms of avoiding the problem that the permeability and magnetization become small when the content is less than the above value. In addition, setting the content of the iron component (Fe component) to 94.5 atom % or less in the magnetic material composition is preferable from the viewpoint of avoiding the problem similar to the case where the soft magnetic metal phase containing a large amount of Fe is separated and the R component is insufficient (that is, when the R component content is less than 2 atom %) if the content of the Fe component exceeds the above value. When the composition range of the iron component (Fe component) is 40 atom % or more and 85 atom % or less, the balanced material having a high permeability and a natural resonance frequency or a maximum absorption frequency in a more preferable range is obtained, and thus the composition range is particularly preferable.

The “M component” in the “rare earth-iron-M-nitrogen-based magnetic material (i.e., R—Fe-M-N-based magnetic material)” used as the “high-frequency magnetic material” of the present invention is at least one element selected from the group consisting of Ti, V, Mo, Nb, W, Si, Al, Mn, and Cr. The introduction of the M component is necessary to particularly produce a rare earth-iron-M-nitrogen-based magnetic material having a tetragonal crystal structure. In addition, when a nitriding method using a mixed gas of ammonia and hydrogen is applied, the rare earth-iron-M-nitrogen-based magnetic material can be made into an amorphous material at a relatively low temperature, a low partial pressure, and a short time, and the amorphous high-frequency magnetic material of the present invention, which is homogeneous, has a high permeability, and has a high natural resonance frequency or maximum absorption frequency, can be prepared compared with the case of not containing the M component.

In the case of a tetragonal rare earth-iron-M-nitrogen-based magnetic material, there are three kinds of sites of the M component in the crystal structure, 8i, 8j, and 8f, but the occupancy position thereof differs depending on the M component. Ti, V, Mo, Nb, and W mainly occupy 8i sites, and some rare earth-iron-M-nitrogen-based magnetic materials containing the M component can be an in-plane anisotropy material, and become a high-frequency magnetic material having high permeability in a high frequency region. Conversely, when the M component is Si or Al, it mainly enters the 8j and 8f sites. When the amount of the N component is more than 7 atom % in the R—Fe-M-N-based magnetic material containing the M component, the high-frequency magnetic material that can be used particularly in an ultra-high frequency region is obtained. When the M component is Mn or Cr, it occupies all the sites of 8i, 8j, and 8f. In particular, when the M component amount is in a range of more than 7 atom % and 25 atom % or less, it has a high maximum absorption frequency.

The content of the M component in the “rare earth-iron-M-nitrogen-based magnetic material (i.e., R—Fe-M-N-based magnetic material)” needs to be 0.5 atom % or more and 25 atom % or less.

In particular, in the case of preparing a tetragonal rare earth-iron-M-nitrogen-based magnetic material, the content is preferably 2 atom % or more. In the case of producing an amorphous rare earth-iron-M-nitrogen-based magnetic material, the amount of the M component needs to be 0.5 atom % or more in order to stabilize the structure thereof. In any crystal structure, the inclusion of the M component provides a high-frequency magnetic material having very high permeability and maximum absorbed energy coefficient. In addition, when the amount of the M component in the rare earth-iron-M-nitrogen-based magnetic material exceeds 25 atom %, not only the permeability is very low, which is not preferable, but also a preferable crystal structure cannot be maintained.

In the description relating to the present invention in the present application, when being expressed as “iron component” or “Fe component” or when being expressed as “Fe” or “iron” in a formula such as “R—Fe-M-N-based” or in the context of discussing the composition of the magnetic material, unless otherwise specified, the present invention may also include a composition in which 50 atom % or less of iron (Fe), which is a basic component of “rare earth-iron-M-nitrogen-based magnetic material” in the high-frequency composite magnetic material of the present invention, is substituted with a ferromagnetic element of Co or Ni. In this case, it is preferable to substitute 0.01 atom % or more and 50 atom % or less of the iron component (i.e., Fe component) with Co or Ni, but it is particularly preferable to substitute 1 atom % or more and 50 atom % or less of the iron component (i.e., Fe component) with Co or Ni component in order to achieve a higher permeability in order to obtain high oxidation resistance performance.

It is preferable that the substitution amount of the Co or Ni component is 50 atom % or less of the iron component (i.e., Fe component) in order to avoid the following problems: when the substitution amount exceeds the above value, not only the problem that the above effect provided by a manufacturing cost increase is small and thus merit thereof cannot be obtained in terms of cost performance but also the problem that magnetic properties become unstable. In addition, it is preferable that the substitution amount of the Co or Ni component is 0.01 atom % or more of the iron component (i.e., Fe component) in order to avoid the problem that the substitution effect is hardly observed when the substitution amount is less than the above value.

As described above, the present invention is characterized by using a “rare earth-iron-M-nitrogen-based magnetic material” as a high-frequency magnetic material, and is a magnetic material that can be used in a high frequency region that is difficult when an oxide magnetic material or a metal-based magnetic material is used. In order to develop a particularly excellent “target function”, it is desirable that the content of nitrogen (N), which is a basic component of the “rare earth-iron-M-nitrogen-based magnetic material” used in the present invention, is in a range of 3 atom % or more and 50 atom % or less in the magnetic material composition. It is preferable to set the content of the nitrogen (N) component to 50 atom % or less in order to avoid the problem that the permeability generally decreases if the content of the N component exceeds the above value. In addition, the content of the nitrogen (N) component is preferably 3 atom % or more in order to avoid the problem that the permeability in a high frequency region or an ultra-high frequency region is not sufficiently improved if the content of the N component is less than the above value. In the case of a tetragonal rare earth-iron-M-nitrogen-based magnetic material, the content of the nitrogen component is preferably 3 atom % or more and 25 atom % or less, depending on the kind and content of the rare earth component and the M component, and in the case of an amorphous rare earth-iron-M-nitrogen-based magnetic material, the content of the nitrogen component is preferably 10 atom % or more and 50 atom % or less. In the case of a tetragonal rare earth-iron-M-nitrogen-based magnetic material whose crystal is thermodynamically unstable compared with a rhombohedral or hexagonal rare earth-iron-M-nitrogen-based magnetic material, amorphization thereof easily generates in a region where the nitrogen content is smaller, and nitridization and amorphization thereof generate at a low temperature and a short time, so that a crystal phase such as an iron nitride, a rare earth nitride, and a nitride of the M component is not separated, and the whole is homogeneously nitrided and amorphized. This is the reason why a tetragonal rare earth-iron-M raw material alloy is preferably used in preparing the magnetic material of the present invention.

The inclusion of nitrogen in the magnetic material used as the high-frequency magnetic material of the present invention is one of the important characteristics in terms of composition in the high-frequency magnetic material of the present invention, and one of the main effects thereof is an increase in electric resistivity. As a result, when the eddy current loss increases, the real term of the complex relative permeability decreases, and a problem that large electromagnetic wave absorption due to natural resonance in a high frequency region or an ultra-high frequency region is hindered can be solved. In particular, this effect is remarkable in the amorphous rare earth-iron-M-nitrogen-based magnetic material of the present invention.

In the material having the same level as permeability, the larger the electrical resistivity, the higher the critical frequency at which the eddy current is generated. Therefore, in the high frequency magnetic material of the present invention, since a predetermined amount of nitrogen is contained in the magnetic material, the electric resistivity increases, and the eddy current loss does not become remarkable until the high frequency region corresponding to the high natural resonance frequency inherent to the R—Fe-M-N-based magnetic material is reached. Therefore, a high complex relative permeability real term can be maintained up to a high frequency region including an ultra-high frequency region, and the effect of natural resonance can be sufficiently exhibited in a higher frequency region, so that a high complex relative permeability imaginary term can be achieved in a high frequency region including an ultra-high frequency region.

In addition, in the case of using the material as a high frequency amplifying material at a frequency of 0.001 GHz or more and 0.1 GHz or less, when an eddy current loss occurs in the frequency region, the temperature of the material increases or the real term of the permeability decreases, so that efficiency is deteriorated, which is not preferable. From such a viewpoint, in order to further improve the electric resistivity of the rare earth-iron-M-nitrogen-based magnetic material and to obtain a high frequency magnetic material that can be suitably used even in an ultra-high frequency region of 1 GHz or more, it is more desirable to control the content of nitrogen (N), which is the basic component of the “rare earth-iron-M-nitrogen-based magnetic material” used in the present invention, in the “highly nitriding (which is also referred to as “highly nitrided”)” range of 7 atom % or more and 30 atom % or less. From the viewpoint of simplification of the step, the range of 10 atom % or more and 25 atom % or less in which the annealing treatment after the nitriding step is not essential is further preferable, and the rare earth-iron-nitrogen-based magnetic material prepared in such a range of the amount of nitrogen has a particularly high natural resonance frequency and electric resistivity. In addition, the R—Fe-M-N-based magnetic material in the highly nitrided region is prepared by using a nitriding step by a gas phase reaction using a gas containing ammonia. For example, when nitrogen gas is used, it is difficult to obtain a homogeneously and highly nitrided material.

The most preferable range (that is, the optimum range) of the nitrogen amount may vary depending on the intended use, the R—Fe-M composition ratio, the amount ratio of the sub-phase, the crystal structure of the R—Fe-M-N-based magnetic material, and the like. For example, when Sm_{7.7}Fe_{84.6}Ti_{7.7} having a rhombohedral structure is selected as a raw material alloy, the optimum nitrogen amount exists in the vicinity of the range of 5 atom % or more and 10 atom % or less within the range of 3 atom % or more and 50 atom % or less. The optimum amount of nitrogen at this time varies depending on the purpose, but it is the amount of nitrogen that optimizes at least one of the oxidation resistance performance, magnetic properties, and electrical properties of the material.

Here, the “magnetic properties” means at least one of permeability (μμ₀), relative permeability (μ), complex permeability (μᵣμ₀), complex relative permeability (μᵣ) of the material, a real term (μ′), an imaginary term (μ″), and an absolute value (|μᵣ|) thereof, a maximum value of μ″ (μ″ₘₐₓ) in any frequency region in frequency dependence of the complex relative permeability imaginary term and a frequency at that time (fₐ: this frequency is referred to as a “maximum absorption frequency”), a maximum value of μ′ (μ′ₘₐₓ) in any frequency region in frequency dependence of the complex relative permeability real term and a frequency at that time (fₜ), a maximum absorbed energy coefficient (fμ″ₘₐₓ) that is a maximum value when a product (fμ″) of a value of a complex relative permeability imaginary term (μ″) at a certain frequency (f) and the frequency (f) is referred to as an “absorbed energy coefficient”, magnetization (Iₛ), a uniaxial magnetic anisotropy magnetic field or an in-plane magnetic anisotropy magnetic field (Hₐ, Hₐ₁, Hₐ₂), an absolute value of magnetic anisotropy energy (Eₐ), a magnetic anisotropy ratio (p/q: when a magnetic material is uniaxially magnetically oriented in an orientation magnetic field of 1.2 MA/m, the magnetization in an external magnetic field of 1.0 MA/m in an applied orientation magnetic field direction is defined as q, and the magnetization in an external magnetic field of 1.0 MA/m perpendicular to it is defined as “p”), a temperature change rate of permeability, and a natural resonance frequency (fᵣ) with an external alternating magnetic field caused by an electromagnetic wave or the like.

“Electrical properties” refer to electric resistivity (=volume resistivity ρ), electrical conductivity (σ), impedance (Z), inductance (L), capacitance (C), reactance (R), permittivity (εε₀), relative permittivity (ε), complex permittivity (εᵣε₀), complex relative permittivity (εᵣ) of a material, a real term (ε′), an imaginary term (ε″), and an absolute value (|εᵣ|) thereof, and a loss term (εₜ=ε″+σ/ω) in complex relative permittivity, which is a combination of dielectric loss and conductive loss, and εₜ is referred to as an electrical loss term. Symbol “ω” represents an angular frequency).

The “magnetic properties” and the “electrical properties” are collectively referred to as “electromagnetic properties”. In general, there is a case where a notation in which a horizontal bar (−) is added above the symbols “μ” and “ε” representing relative permeability and relative permittivity is adopted, but in the present application, the relative permeability is represented as “μ” and the relative permittivity is represented as “ε”. The permeability can be regarded as a complex permeability absolute value when f→0, and the permittivity can be regarded as a complex permittivity absolute value when f→0.

The “permeability” is obtained by multiplying the relative permeability (μ) by the vacuum permeability (μ₀), and the “permittivity” is obtained by multiplying the relative permittivity (ε) by the vacuum permittivity (ε₀).

In the description relating to the present invention in the present application, for example, the expression “permeability is high”, or the expression “relative permeability is high” which has the same meaning as the expression “permeability is high” means the following: in addition to the permeability or the relative permeability of the material in a static magnetic field is high, the absolute value of the complex permeability or the complex relative permeability is high in an AC magnetic field in which an electromagnetic wave is acting, the value of the complex relative permeability real term is high when the value of the complex relative permeability imaginary term is close to 0, and conversely, the value of the complex relative permeability imaginary term is high when the value of the complex relative permeability real term is close to 0. The above relationship also applies to the “permittivity” and the “relative permittivity”, and thus can be understood as it is by replacing the “permeability” and the “relative permeability” in the above description with the “permittivity” and the “relative permittivity”, respectively.

Next, a state in which the magnetic properties or the electrical properties are optimal will be described.

The state in which the magnetic properties or the electrical properties are optimal means the following: a value such as the permeability; a real term or an imaginary term in a high frequency region of the complex relative permeability; magnetization; a Curie point; an electric resistivity; and a real term, an imaginary term, or a loss term of a permittivity; and a complex relative permittivity become maximum, and a value such as an absolute value of a temperature change rate of the permeability and magnetization; and electrical conductivity become minimum. As for the magnetic anisotropy ratio, the magnetic anisotropic magnetic field, the magnetic anisotropy energy, and the like having a close relationship with the natural resonance frequency, a state in which natural resonance occurs at a desired frequency or a state in which the value is set such that the absorption of the electromagnetic wave becomes maximum is referred to as being optimal.

Each composition of the R—Fe-M-N-based magnetic material in the present invention is in a range of 2 atom % or more and 15 atom % or less of the R component (rare earth component), 10 atom % or more and 94.5 atom % or less of the Fe component (iron component), 0.5 atom % or more and 25 atom % or less of the M component, and 3 atom % or more and 50 atom % or less of the N component (i.e., nitrogen component), and satisfies these at the same time.

Furthermore, in the R—Fe-M-N-based magnetic material obtained in the present invention, hydrogen (H) may be contained in an amount of 0.01 atom % or more and 10 atom % or less in the magnetic material composition.

When H is contained in the above composition range, oxidation resistance performance and permeability are improved. In the composition of the R—Fe-M-N-based magnetic material of the present invention in this case, when expressed by the general formula RₓFe_{(100-x-y-z-α)}M_{y}N_{z}H_{α}, wherein each value of the x, y, z, and a satisfies four formulas of 2≤x/(1−α/100)≤15, 0.5≤y/(1−α/100)≤25, 3≤z/(1−α/100)≤50, and 0.01≤a≤10 in atom %, and each value of the x, y, z, and α is selected so that these four formulas are simultaneously established.

Furthermore, depending on the production method, oxygen (O) may be contained at 0.1 atom % or more and 20 atom % or less, and in this case, the stability of magnetic properties is improved, and a magnetic material having high electric resistivity can be obtained. Therefore, in a more preferable composition of the R—Fe-M-N—H—O-based magnetic material of the present invention, when represented by the general formula RₓFe_{(100-x-y-z-a-β)}M_{y}N_{z}H_{α}O_{β}, wherein each value of the x, y, z, α, and β satisfies five formulas of 2≤x/{(1−α/100)(1−β/100)}≤15, 0.5≤y/{(1−α/100)(1−β/100)}≤25, 3≤z/{(1−α/100)(1−β/100)}≤50, 0.01≤α/(1−β/100)≤10, and 0.1≤β≤20 in terms of atom %, and each value of the x, y, z, α, and β is selected so that these five formulas are simultaneously established. If this oxygen component is localized on the surface of the magnetic powder, the effect of improving the electric resistivity is high, and for this purpose, a method of applying various surface oxidation treatments including an acid treatment, an alkali treatment, a heat treatment, a coupling treatment, and the like to the powder surface before and after nitridization and before and after fine powder preparation is also effective.

The amount of less than 50 atom % in the nitrogen (N) component of the “rare earth-iron-M-nitrogen-based magnetic material (R—Fe-M-N-based magnetic material)” used as the “high-frequency magnetic material” of the present invention may be substituted with at least one element selected from the group consisting of H, C, P, Si, and S. In this case, it is preferable to substitute the amount of 0.01 atom % or more and less than 50 atom % in the nitrogen (N) component of the rare earth-iron-M-nitrogen-based magnetic material (R—Fe-M-N-based magnetic material) with at least one element selected from the group consisting of H, C, P, Si, and S. When the nitrogen (N) component is substituted with at least one of these elements, depending on the kind and amount of the element to be substituted, not all the elements are substituted with the N component, or not all the elements are substituted with the N component on a one-to-one basis. However, due to the kind and amount of the substituted element, improvement in electromagnetic properties of oxidation resistance performance, permeability, permittivity, and so on can be occasionally brought about, and when used in a high-frequency resin composite magnetic material, affinity with a resin component is improved, and improvement in mechanical properties can be expected.

Substitution of 0.01 atom % or more in the nitrogen (N) component with at least one of the above elements is preferable in terms of avoiding the problem that the effect provided by the above substitution is almost lost when the substitution amount is less than the above value. In addition, substitution of less than 50 atom % in the nitrogen (N) component with at least one of the above elements is more preferable in terms of avoiding the problem of impairing the effect provided by nitrogen in the improvement of the electric resistivity and the optimization of the resonance frequency when the substitution amount exceeds the above value.

In the description relating to the present invention in the present application, when expressed as “nitrogen component” or “N component”, or when expressed as “N” or “nitrogen” in the context discussing the formulas on “rare earth-iron-M-nitrogen-based magnetic material” and “R—Fe-M-N-based” and the like and the composition of the magnetic material thereof, unless otherwise specified, the present invention also includes a composition in which an amount of 0.01 atom % or more and less than 50 atom % of nitrogen (N) as a basic component of the “rare earth-iron-M-nitrogen-based magnetic material” in the high-frequency magnetic material of the present invention is substituted with at least one element selected from the group consisting of H, C, P, Si, and S.

The “rare earth-iron-M-nitrogen-based magnetic material” used as the “high-frequency magnetic material” of the present invention preferably contains a phase having at least one crystal structure selected from tetragonal, rhombohedral, hexagonal crystal, and amorphous state as a main phase, and more preferably contains a phase having a tetragonal or amorphous crystal structure. In the present invention, a phase that forms these crystal structures and contains at least R (rare earth), Fe (iron), M (M component), and N (nitrogen) is referred to as a “main phase”, and a phase having a composition that forms another crystal structure that is not the crystal structure is referred to as a “sub-phase”. The sub-phase means a phase that is not a main phase generated intentionally or unintentionally in the process of producing a rare earth-iron-M-nitrogen (-hydrogen-oxygen)-based magnetic material from a rare earth-iron raw material. Components of the main phase can contain H (hydrogen) and/or O (oxygen) in addition to R (rare earth), Fe (iron), M (M component), and N (nitrogen).

Examples of the preferred crystal structure of the main phase include a crystal structure containing at least one of a tetragonal crystal having a crystal structure similar to that of ThMn₁₂ or the like, a rhombohedral crystal having a crystal structure similar to that of Th₂Zn₁₇ or the like, a hexagonal crystal having a crystal structure similar to that of Th₂Ni₁₇, TbCu₇, CaZn₅ or the like, or amorphous state (the amorphous state is also referred to as amorphous, or is sometimes referred to as amorphous nitride because of being amorphized in the nitriding step).

Among them, it is particularly preferable to have or contain a tetragonal crystal or an amorphous crystal having a crystal structure similar to ThMn₁₂ or the like as the main phase in order to secure good electromagnetic properties and stability thereof.

The R—Fe-M-N-based magnetic material may contain, as a sub-phase, a hydride phase, a decomposed phase containing Fe nanocrystals, an oxidized amorphous phase, or the like in an R—Fe-M alloy raw material phase. However, in order to sufficiently exhibit the effect of the present invention, the volume fraction of the sub-phase needs to be kept lower than the content of the main phase. Therefore, the content of the main phase is preferably more than 50 vol % and further preferably more than 75 vol % with regard to the entire R—Fe-M-N-based magnetic material in practice. In many cases, the main phase of the R—Fe-M-N-based magnetic material is obtained by the following: nitrogen enters between lattices of the R—Fe-M alloy that is the main raw material phase, and thus the crystal lattice expands, or the crystal structure collapses or begins to collapse by exceeding the limitation of the lattice expansion. However, the crystal structure before becoming amorphous has substantially the same symmetry as the main raw material phase.

The R—Fe-M-N-based magnetic material of the tetragonal, rhombohedral, or hexagonal main raw material phase is subjected to the nitriding treatment using the R—Fe-M alloy raw material phase having the same symmetry as a raw material. On the other hand, the amorphous R—Fe-M-N-based magnetic material has a tetragonal, rhombohedral, or hexagonal structure in which the main raw material phase has been nitrided and its crystal structure has been collapsed. This phenomenon is referred to as “nitridization and amorphization” or “nitrided and amorphized” (or “nitriding and amorphizing”). The tetragonal R—Fe-M alloy raw material phase is easily amorphized by the nitriding treatment compared with the rhombohedral or hexagonal R—Fe-M alloy raw material phase, and is particularly preferable as a raw material of an amorphous R—Fe-M-N-based magnetic material.

The term “volume fraction” as used herein refers to the ratio of the volume occupied by a certain component in the total volume including voids of the magnetic material.

In the present application, the “main raw material phase” means a phase that contains at least R (i.e., rare earth), Fe, and M components, does not contain N, and further has at least one crystal structure selected from tetragonal, hexagonal, and rhombohedral crystal (in particular, rhombohedral or hexagonal crystal) (A phase having the other composition or crystal structure and containing no N is referred to as a “sub-raw material phase” in the present application.).

With the expansion of the crystal lattice due to the entry of nitrogen, at least one of the oxidation resistance performance and the magnetic properties and the electrical properties of the material are improved, and the R—Fe-M-N-based magnetic material suitable for practical use is obtained. After the introduction of nitrogen, the magnetic material becomes a suitable high-frequency magnetic material for the first time, and exhibits electromagnetic properties completely different from those of the conventional nitrogen-free R—Fe-M alloy and Fe.

For example, when Sm_{7.7}Fe_{77.0}Co_{3.8}Mo_{11.5} having a rhombohedral structure is selected as the main raw material phase of the mother alloy of the R—Fe-M component, the electric resistivity is increased by introducing nitrogen, and the magnetic properties including the Curie point, the absolute values of the permeability and the magnetic anisotropy energy, and the oxidation resistance performance are improved.

The rare earth-iron-M-nitrogen-based magnetic material used as the “high-frequency magnetic material” of the present invention is desirably a material utilizing the in-plane magnetic anisotropy thereof. The in-plane magnetic anisotropic material is a material that is energetically more stable when the magnetic moment exists on the c-plane due to the presence of the magnetic moment on the c-axis.

The Sm—Fe-M-N-based magnetic material having a rhombohedral or hexagonal crystal structure is not an in-plane magnetic anisotropic material but a uniaxial magnetic anisotropic material, and practical application as a magnet material has been studied. However, when it is attempted to use a magnet material of a uniaxial magnetic anisotropic material that is not such an in-plane magnetic anisotropic material as a magnetic material for high frequency use applications, as described above, the magnet material mostly functions only in a high ultra-high frequency region exceeding 100 GHz, and has low permeability in the ultra-high frequency region. In order to avoid such a problem, the content of the Sm—Fe-M-N-based magnetic material is preferably less than 50 vol % of the total magnetic material.

In addition, similarly to the Sm—Fe-M-N-based magnetic material, it cannot be said that a known rare earth-based magnetic material such as a Sm—Fe—Ti-based material, a Nd—Fe—B-based material, and a Sm—Co-based material which is a tetragonal system but is not a nitride and which has uniaxial magnetic anisotropy instead of in-plane magnetic anisotropy is suitable as a high-frequency magnetic material. This is because magnetic materials for Nd—Fe—B-based or Sm—Co-based magnet have uniaxial anisotropy in magnetocrystalline anisotropy, and are also metal-based magnetic materials, and thus have low electric resistivity, and decrease in permeability in a high frequency region due to eddy current loss is observed.

If the rare earth-iron-M-nitrogen-based magnetic material of the present invention is not a material utilizing in-plane magnetic anisotropy, it is desirable that the rare earth-iron-M-nitrogen-based magnetic material is an isotropic amorphous material obtained by nitriding and amorphizing a tetragonal raw material alloy. This material is an amorphous nitride containing a large amount of nitrogen and has high electric resistance, so that reduction in permeability due to eddy current loss is significantly suppressed even when the powder particle diameter is large. Since the nitrogen content is large, the value of magnetization is smaller than that of the rare earth-iron-M-nitrogen-based magnetic material utilizing the in-plane anisotropy of the present invention, but the permeability is kept high up to the ultra-high frequency region.

When the high-frequency magnetic material of the present invention is a powder, it is preferably a powder having an average particle diameter of 0.1 μm or more and 2000 μm or less, and more preferably a powder having an average particle diameter of 0.2 μm or more and 200 μm or less. Here, the “average particle diameter” means a median diameter obtained based on a volume equivalent diameter distribution curve obtained by a generally used particle diameter distribution measuring apparatus.

Setting the average particle diameter to 0.1 μm or more is preferable in terms of avoiding the following: ignitionability of the powder occurs, and production process becomes complicated for the reasons that handling of the powder in a low oxidation atmosphere is required in order to avoid the ignitonability, and so on. Setting the average particle diameter to 2000 μm or less is preferable in terms of avoiding, in addition to the problem that it is difficult to produce a homogeneous nitride, the problem that a material having poor absorption of an electromagnetic wave at 0.001 GHz or more is produced. Therefore, the high-frequency magnetic material of the present invention is a powder having an average particle diameter of 0.1 μm or more and 2000 μm or less.

In addition, when the average particle diameter is less than 0.2 μm, a decrease in permeability and aggregation of the magnetic powder are remarkable, so that the magnetic properties inherent to the material cannot be sufficiently exhibited, and the magnetic powder is in a region that is not suitable for general industrial production. Therefore, it cannot be said that the above average particle diameter is in a very appropriate particle diameter range. On the other hand, even when the average particle diameter is less than 0.2 μm, there is an advantage that the magnetic powder is suitable for high-frequency magnetic materials for thin-walled and ultra-compact special applications because oxidation resistance performance is overwhelmingly excellent compared with a nitrogen-free metal-based high-frequency magnetic material. Also from such a viewpoint, in the high-frequency magnetic material of the present invention, the lower limit value of the average particle diameter is preferably set to 0.1 μm which is less than 0.2 μm.

However, as described above, setting the average particle diameter to 0.2 μm or more is preferable in terms of avoiding the above problem occurring when the average particle diameter is less than the above value.

In addition, setting the average particle diameter to 200 μm or less is preferable in terms of avoiding the problem that the permeability in a high frequency region is reduced when the average particle diameter exceeds the above value.

When the average particle diameter is in the range of 0.5 μm or more and 10 μm or less, fₐ is in a high frequency region and the material having high permeability is obtained, and the material having a high selective absorption ratio at 0.1 GHz or more is easily obtained.

When the average particle diameter is in the range of 10 μm or more and 200 μm or less, the high permeability and the value of the imaginary term of permeability decreases, and the high frequency amplifying material in the range of 0.001 GHz or more and 0.1 GHz or less is easily obtained.

In the case where the “high-frequency magnetic material” of the present invention is an amorphous rare earth-iron-nitrogen-based magnetic material, since the electrical resistance is high, even when the average particle diameter is in the range of 1 μm or more and 200 μm or less, it can be a high frequency amplifying material such as a magnetic field amplifying material used in the range of 0.001 GHz or more and 0.1 GHz or less.

The “rare earth-iron-M-nitrogen-based magnetic material” used as the high-frequency magnetic material of the present invention may mix (which is referred to as blend) at least one selected from the group consisting of the following: a metal-based magnetic material such as a metal Fe, a metal Ni, a metal Co, an Fe—Ni-based alloy, an Fe—Ni—Si-based alloy, sendust, an Fe—Si—Al-based alloy, an Fe—Cu—Nb—Si-based alloy, and an amorphous alloy; and an oxide-based magnetic material such as: a magnetite; a garnet-type ferrite such as a Ni-ferrite, a Zn-ferrite, a Mn—Zn ferrite, and a Ni—Zn ferrite; and a soft magnetic hexagonal magnetoplumbite ferrite. That is, the metal-based magnetic material and the oxide-based magnetic material to be mixed may be one kind or two or more kinds thereof. In addition, the forms of these metal-based magnetic materials and oxide-based magnetic materials to be mixed are not particularly limited. For example, when metal Fe, metal Ni, and metal Co are taken as examples of the metal-based magnetic material to be mixed, these forms are not particularly limited, and for example, may be in the form of a metal powder, or may be in the form of a metal foil or the like.

When the above mixed material is applied to an electromagnetic wave absorbing material, a frequency band for absorbing an electromagnetic wave can be expanded from a high frequency region to a low frequency region, or a broad absorption characteristic can be imparted even in a high frequency region to absorb noise in a wide band. In particular, when carbonyl iron having a particle diameter of 0.1 μm or more and 100 μm or less is used as the metal Fe of the mixed material, the high-frequency magnetic material having a good balance between permeability of less than 1 GHz and permeability of 1 GHz or more is obtained. The reason why high properties are obtained when the carbonyl iron is mixed with the rare earth-iron-M-nitrogen-based material is as follows: [1] the circularity of the carbonyl iron is very high as 0.7 or more and 1 or less, and electrical insulation properties is excellent, and [2] when mixing the rare earth-iron-M-nitrogen-based magnetic material and the carbonyl iron are mixed in powder form, since the signs of the electric charge of the surfaces of the carbonyl iron as a metal powder and the rare earth-iron-M-nitrogen material as a nitride powder are different from each other, homogeneous mixing is easy.

In the high-frequency magnetic material of the present invention used at ultra-high frequency, when carbonyl iron is used as a magnetic material (i.e., mixed material) to be mixed with a rare earth-iron-M-nitrogen-based magnetic material, a preferable average particle diameter range of the carbonyl iron powder is 1 μm or more and 10 μm or less.

In the high-frequency composite magnetic material of the present invention, the amount of a material (that is, a magnetic material different from the rare earth-iron-M-nitrogen-based magnetic material or a nonmagnetic material (for example, a nonmagnetic ceramic material and/or a resin)) mixed to make a composite with the rare earth-iron-M-nitrogen-based magnetic material is preferably 0.001% by mass or more and 99% by mass or less of the total magnetic material in the high-frequency composite magnetic material of the present invention. The amount of 0.001% by mass or more is preferable in terms of obtaining the effect of adding the metal-based magnetic material or the oxide-based magnetic material used as the mixed material, and the amount of 99% by mass or less is preferable in terms of obtaining the effect on various electromagnetic properties of the rare earth-iron-M-nitrogen-based magnetic material of the present invention.

Therefore, for example, in the high-frequency composite magnetic material of the present invention, when mixing at least one selected from the group consisting of the following: a metal-based magnetic material such as a metal Fe, a metal Ni, a metal Co, an Fe—Ni-based alloy, an Fe—Ni—Si-based alloy, sendust, an Fe—Si—Al-based alloy, an Fe—Cu—Nb—Si-based alloy, and an amorphous alloy; an oxide-based magnetic material such as a magnetite, a Ni-ferrite, a Zn-ferrite, a Mn—Zn ferrite, and a Ni—Zn ferrite; and a soft magnetic hexagonal magnetoplumbite ferrite, the amount of the rare earth-iron-M-nitrogen-based magnetic material is in the range of 1% by mass or more and 99.999% by mass or less, and the amount of at least one selected from the group consisting of the metal-based magnetic materials and the oxide-based magnetic materials to be mixed is preferably in a range of 0.001% by mass or more and 99% by mass or less. In addition, for example, in the high-frequency composite magnetic material of the present invention, when a ceramic material is used as the above mixed material, the amount of the rare earth-iron-M-nitrogen-based magnetic material is preferably 1% by mass or more and 99.999% by mass or less, and the amount of the ceramic material is preferably 0.001% by mass or more and 99% by mass or less.

When the mass fraction of the amounts of the metal-based magnetic material and oxide-based magnetic material other than the rare earth-iron-M-nitrogen-based magnetic material with regard to the total magnetic material are in the range of 0.05% by mass or more and 75% by mass or less, it can be more effectively exhibited.

In addition, when the mass fraction of the amounts of the metal-based magnetic material and oxide-based magnetic material other than the rare earth-iron-M-nitrogen-based magnetic material with regard to the total magnetic material are 0.01% by mass or more and 50% by mass or less, the characteristics of the electrical properties of the rare earth-iron-M-nitrogen-based magnetic material can be more effectively exhibited.

Therefore, when the mass fraction of the amounts of the metal-based magnetic material and oxide-based magnetic material other than the rare earth-iron-M-nitrogen-based magnetic material with regard to the total magnetic material are 0.05% by mass or more and 50% by mass or less, both the characteristics like absorption of the rare earth-iron-M-nitrogen-based magnetic material in the ultra-high frequency region, and so on and the characteristics of its electrical properties can be more effectively exhibited together.

Among the high-frequency composite magnetic materials of the present invention using the rare earth-iron-M-nitrogen-based magnetic material as well as the high-frequency resin composite magnetic materials of the above high-frequency composite magnetic materials, there are materials of which a value of an imaginary term of a complex relative permittivity at 1 GHz or more, that is, a value of an electrical loss term exceeds 10 or materials of which a high value of an electrical loss term exceeds further exceeds 50, wherein the materials have, as a representative value of an electric resistivity of the rare earth-iron-M-nitrogen-based magnetic material itself, a range value of 200 μΩcm or more and 8000 μΩcm or less, and have an appropriate size located in the middle of the nitrogen-free metal-based magnetic material and the oxide magnetic material. When an electronic circuit is used as an electromagnetic wave source, the electromagnetic wave in the far field (This means the compartment at a distance greater than 1/2π of the wavelength from the source of the electromagnetic wave. The non-far-field compartment is referred to as near-field.) is an electromagnetic wave with a sufficiently large electric field E as well as the magnetic field H. Therefore, the high-frequency composite magnetic material of the present invention using the rare earth-iron-M-nitrogen-based magnetic material is very suitably utilized because of being a magnetic material having a high permittivity even in uses in an ultra-high frequency region like absorption of noise exceeding 1 GHz, and so on and uses like a far-field electromagnetic wave absorber used in an anechoic chamber, and so on. Also in the case of blending (i.e., mixing) the metal-based magnetic material or the oxide-based magnetic material described above, it is preferable to sufficiently take advantage of this characteristic.

Next, a ceramic material used in the “composite magnetic material” which is the high frequency magnetic material of the present invention is described.

The electrical magnetic properties of the rare earth-iron-M-nitrogen-based magnetic material have intermediate properties between the metal material and the oxide material as described above, but the chemical properties of the surface of the magnetic material also have intermediate properties between the metal material and the oxide material. Therefore, in the case where the rare earth-iron-M-nitrogen-based magnetic material is mixed in a powder form, when an operation of placing the rare-earth-iron-M-nitrogen-based magnetic material in a container and shaking up (which is also referred to as “shaking” hereinafter) the mixture is performed, the electric charge states of the powder surfaces of the rare earth-iron-M-nitrogen-based magnetic material and the metal material or the rare earth-iron-M-nitrogen-based magnetic material and the oxide material are divided into positive and negative, and the mixture can be easily mixed in a homogeneous state.

Therefore, it is preferable to use an oxide-based ceramic material for the purpose of providing electrical insulation between the rare earth-iron-M-nitrogen-based magnetic material powder particles and reducing the eddy current loss.

In particular, when the oxide-based ceramic material is a nanopowder of less than 1 μm, a high-frequency composite magnetic material having a high packing factor and a high resistance can be achieved. In particular, the rare earth-iron-M-nitrogen-based magnetic material and the nano oxide-based ceramic material have an advantage that they can be homogeneously mixed in a short time even by a simple operation such as shaking, and have an advantage that it can be magnetically oriented similarly to the high-frequency resin composite magnetic material if various magnetic field molding described later is performed after the homogeneous mixing.

Representative examples of the oxide-based material include silica, alumina, chromium oxide, zirconia, magnesia, rare earth oxide, and the like, and oxides or composite oxides containing at least one selected from the group consisting of Co, Ni, Ti, V, Mo, Nb, W, Si, Al, Mn, and Cr, including rare earth and Fe which are basic components of the rare earth-iron-M-nitrogen-based magnetic material, are suitable. Fe oxide is also a ceramic material that can be used in the present invention.

As described above, the ceramic material used in the composite magnetic material of the present invention is preferably a nanoceramic material from the viewpoint of the isolated dispersibility of the rare earth-iron-M-nitrogen-based magnetic material powder, and thus is preferably a powder having an average particle diameter of 1 nm or more and less than 1000 nm. In the present invention, when the nanoceramic material is described, the case of silica of 1 nm or more and 1000 nm or less may be described by adding nano to the front of the material name, like “nanosilica”.

Next, a “high-frequency resin composite magnetic material” that is the high frequency magnetic material of the present invention is described.

Examples of the resin component that can be used as the resin component of the high-frequency resin composite magnetic material are as follows.

For example, a polyamide-based resin such as a polyamide-based resin such as nylon 12, nylon 6, nylon 6,6, nylon 4,6, nylon 6/12, an amorphous polyamide, and a semi-aromatic polyamide; a polyolefin-based resin such as a polyethylene, a polypropylene, and a chlorinated polyethylene; a polyvinyl-based resin such as a polyvinyl chloride, a polyvinyl acetate, a polyvinylidene chloride, a polyvinyl alcohol, and an ethylene-vinyl acetate copolymer; an acrylic-based resin such as an ethylene-ethyl acrylate copolymer and a polymethyl methacrylate; an acrylonitrile-based resin such as a polyacrylonitrile and an acrylonitrile/butadiene/styrene copolymer; various polyurethane-based resins; a fluorine-based resin such as a polytetrafluoroethylene; a synthetic resin referred to as an engineering plastic such as a polyacetal, a polycarbonate, a polyimide, a polysulfone, a polybutylene terephthalate, a polyarylate, a polyphenylene oxide, a polyether sulfone, a polyphenyl sulfide, a polyamideimide, a polyoxybenzylene, and a polyether ketone; a thermoplastic resin containing liquid crystal resins such as a wholly aromatic polyester; a conductive polymer such as a polyacetylene; a thermosetting resin such as an epoxy resin, a phenol resin, an epoxy-modified polyester resin, a silicone resin, or a thermosetting acrylic resin; and an elastomer such as a nitrile rubber, a butadiene-styrene rubber, a butyl rubber, a nitrile rubber, an urethane rubber, an acrylic rubber, and a polyamide elastomer.

The resin component of the high-frequency resin composite magnetic material of the present invention is not limited to the resins exemplified above, but when at least one of the resins exemplified above is contained, a high-frequency resin composite magnetic material having high electric resistivity and excellent impact resistance, flexibility, and molding processability can be obtained. The content of the resin component is preferably in a range of 0.1% by mass or more and 95% by mass or less. The content of the resin component is preferably 0.1% by mass or more in terms of avoiding the problem that the effect of the resin such as impact resistance is hardly exhibited when the content is less than the above value, and the content of the resin component is preferably 95% by mass or less in terms of avoiding the following problem: when the content of the resin component exceeds the above value, the permeability and the magnetization are extremely lowered, and thus the practicality as a high-frequency resin composite magnetic material is deteriorated.

In addition, in the case where the components other than the resin material component are only the rare earth-iron-M-nitrogen-based magnetic material, there is no effect of electrical insulation properties provided by the ceramic material part, and thus it is occasionally preferable to further set the content of the resin component to 1% by mass or more and 95% by mass or less.

Furthermore, when the magnetic material component is only a rare earth-iron-M-nitrogen-based magnetic material, in uses in which high permeability and impact resistance are particularly required, the magnetic material component is more preferably in the range of 2% by mass or more and 90% by mass or less, and most preferably in the range of 3% by mass or more and 80% by mass or less for the same reason as described above.

In addition, the content of the magnetic material component in the high-frequency resin composite magnetic material of the present invention is preferably 5% by mass or more and 99.9% by mass or less, more preferably 5% by mass or more and 99% by mass or less, still more preferably 10% by mass or more and 98% by mass or less, and most preferably 20% by mass or more and 97% by mass or less. The content of the magnetic material component is preferably 5% by mass or more in terms of avoiding the problem that the permeability and magnetization are extremely lowered and the practicality as a high-frequency magnetic material is deteriorated when the content is less than the above value, and the content of the magnetic material component is preferably 99.9% by mass or less in terms of avoiding the problem that the effect of the resin such as impact resistance is hardly exhibited when the content of the magnetic material component exceeds the above value.

It should be noted that in the high-frequency resin composite magnetic material of the present invention, a rare earth-iron-M-nitrogen-based magnetic material constituting the high-frequency composite magnetic material to be used is responsible for most of the electromagnetic properties, and when the high-frequency resin composite magnetic material of the present invention is applied to a high-frequency magnetic material, an electromagnetic noise absorbing material, an electromagnetic wave absorbing material, a material for an RFID tag, a core of a coil for a wireless power supply system, or the like, performance utilizing characteristics of the resin of impact resistance, flexibility, molding processability, high electric resistivity, and so on is imparted to the high-frequency composite magnetic material to improve practicality. Therefore, a resin component that does not impair the performance of the high-frequency composite magnetic material used in the present invention and imparts “some characteristic inherent to the resin” can be said to be a very suitable component of the high-frequency resin composite magnetic material of the present invention.

The above “some characteristic inherent to the resin” is not limited to the characteristics of the resin exemplified above, and includes all the known resin characteristics and performances. In addition, by electrically insulating the rare earth-iron-M-nitrogen-based magnetic material used in the present invention with a resin component, the rare earth-iron-M-nitrogen-based magnetic material can be applied to uses other than the high-frequency magnetic material. In particular, in the case where Sm is used as a rare earth component of the rare earth-iron-M-nitrogen-based magnetic material used in the present invention and an amount of the Sm is limited to 50 atom % or more, for example,
i) the rare earth-iron-M-nitrogen-based magnetic material having a small particle diameter and the rare earth-iron-M-nitrogen-based magnetic material having a large particle diameter are mixed to increase packing factor thereof as well as electrical insulation is maintained by the resin, thereby being applied to uses as a low-frequency material exhibiting excellent permeability,
ii) the rare earth-iron-M-nitrogen-based magnetic material having shape magnetic anisotropy is used as well as electrical insulation is maintained by the resin, thereby being applied to uses as a magnetic recording material having increased magnetization.

A titanium-based or silicon-based coupling agent can be added to the high-frequency resin composite magnetic material of the present invention.

In general, when a large amount of a titanium-based coupling agent is added thereto, flowability and molding processability are improved, and as a result, the blending amount of the magnetic powder can be increased, and when magnetic field orientation is performed, the orientation is improved, and a material having excellent magnetic properties is obtained. On the other hand, when a silicon-based coupling agent is used, an effect of increasing mechanical strength is obtained, but flowability is generally deteriorated.

It can be performed to mix and add the titanium-based coupling agent and the silicon-based coupling agent in order to take advantage of both the titanium-based coupling agent and the silicon-based coupling agent.

It can also be performed to add an aluminum-based, zirconium-based, chromium-based, or iron-based coupling agent in addition to the titanium-based or silicon-based coupling agent.

Furthermore, the high-frequency resin composite magnetic material of the present invention can also blend various lubricants, heat resistant antiaging agents, and antioxidants.

When the high-frequency resin composite magnetic material of the present invention is formed into a compound-like powder, the particle diameter thereof has only to be in a region that is easy to handle in each molding step, such as for calendering or injection molding. However, in the present invention, from the viewpoint of oxidation resistance of the powder and stability of magnetic properties, a lower limit of the particle diameter of 0.1 μm or more is desired. Also, a lower limit of the particle diameter of 0.2 μm or more is more desired in order to form a powder further having flowability, and a lower limit of the particle diameter of 10 μm or more is preferable in order to form a powder further having excellent flowability. The upper limit of the particle diameter is not particularly specified, but when the particle diameter is too large, unevenness occurs in the magnetic properties of the molded body, and therefore the particle diameter is preferably 5 cm or less. In particular, when the resin composite magnetic material is 20 mm or less, variations in magnetic properties after molding are further reduced, and when the resin composite magnetic material is 2 mm or less, excellent flowability is also imparted.

In the high-frequency resin composite magnetic material of the present invention, it is difficult to impart magnetism to a resin to be a matrix, and thus the resin composite magnetic material does not have a function of increasing permeability by “electrical insulation—magnetic coupling” and suppressing eddy current loss as in the ferrite-coated rare earth-iron-M-nitrogen-based material described in PATENT LITERATURE 1.

However, when the resin contains a segment having a solubility parameter (which is also referred to as a Solubility Parameter (SP) value) of 10 or more and 15 or less, the high-frequency composite magnetic material (which is referred to as a “magnetic powder” hereinafter), which constitutes the high-frequency resin composite magnetic material of the present invention and exists as a powder, is isolated and dispersed, and the coupling between the magnetic powder particles is uncoupled by the resin as an insulator. Therefore, although it is difficult to achieve a real term of an extremely high permeability, the eddy current loss over the frequency in the high frequency region (particularly, the ultra-high frequency region) can be suppressed. Therefore, for example, when the high-frequency resin composite magnetic material of the present invention is applied as a high frequency amplifying material such as a core of a coil for a wireless power supply system of 0.001 GHz or more and 0.1 GHz or less, an eddy current loss can be extremely reduced. Further, when the high-frequency resin composite magnetic material of the present invention is applied as an electromagnetic wave absorbing material or an electromagnetic noise absorbing material used in an ultra-high frequency region exceeding 1 GHz, a maximum absorption frequency (fₐ) can be increased not to cause reduction of a maximum absorbed energy coefficient (fμ″ₘₐₓ) due to an eddy current. The reason for this is understood as follows: since the segment of the resin having a high solubility parameter has high affinity with the rare earth-iron-M-nitrogen-based powder, the binding on their interface is strong, and the magnetic powder particles are separated from each other, thereby being isolated and dispersed.

Here, the “solubility parameter” is a measure representing intermolecular force, and it is understood that the closer the SP values of two substances are, the more affinity they have. Theoretically, the solubility parameter is calculated from the heat of evaporation of a unit volume of liquid, and thus is defined only by a solvent having a melting point, but the solubility parameter of the resin is also determined based on the solubility in a solvent having a known SP value. In the case where the structure is known even for a resin having no document value, the SP value can be obtained based on the Fedors estimation method, and whether or not the resin is effective for the present invention can be determined by rounding off the SP value to the first decimal place.

Examples of the segment of the resin having a solubility parameter (SP) of 10 or more and 15 or less include the following: a thermoplastic resin such as a polyamide (i.e., SP value of 13 or more and 14 or less), an ester (i.e., SP value of 10 or more and 11 or less), and a polyurethane (SP value of 10); and a thermosetting resin such as an epoxy resin (i.e., SP value of 10 or more and 11 or less). A segment having a low SP value such as a polyether (i.e., SP value of 9), a silicon rubber (i.e., SP value of 7 or more and 8 or less), or a fluorine rubber (i.e., SP value of 7 or more and 8 or less) may be contained in the form of copolymerization or the like. In this case, when the resin is contained as a resin to be used in the high-frequency resin composite magnetic material of the present invention, flexibility of the resin composite magnetic material is imparted, and thus the material is suitable for electromagnetic noise absorbing material applications in which a function as an elastomer is required. In particular, when a polyamide ester ether elastomer obtained by copolymerizing a polyamide having an SP value of 13.6 and a polyether having an SP value of 9.0 is used as a resin component, the resin composite magnetic material that has excellent surface smoothness, achieves isolated dispersion, has a high value of the imaginary term of permeability in the ultra-high frequency region, and has excellent flexibility and impact resistance can be obtained. It is understood that this is because ester bonds are included in addition to a polyamide and a polyether, and segments having various compatibility parameters are included. This is because the ester bond is understood as serving to naturally connect the polyamide component bonded to the surface of the rare earth-iron-M-nitrogen-based magnetic material and the polyether component that is present between the powders and imparts flexibility and the like.

When the solubility parameter (SP) of the segment is 13 or more and 14 or less, the permeability is further improved, and the value of the imaginary term of the complex relative permeability in the ultra-high frequency region can be put in the practical range within a wide range in which the volume fraction of the rare earth-iron-M-nitrogen-based magnetic powder is 30 vol % or more and 80 vol % or less.

As described above, in the case of using a resin in which the solubility parameter (SP) is adjusted in the high-frequency resin composite magnetic material of the present invention, since the chemical properties of the surface act, from such a viewpoint, it is preferable that the resin high-frequency composite magnetic material is not completely coated with the ferrite material.

Next, a method for producing the high-frequency magnetic material of the present invention is described, but is not particularly limited thereto.

The method for producing a high-frequency magnetic material of the present invention also includes a method for producing a high-frequency composite magnetic material or a high-frequency resin composite magnetic material.

As for the production method, in particular, a method for obtaining the “high-frequency composite magnetic material” of the present invention is specifically exemplified.

In the description of the present invention in the present application, “an alloy substantially composed of R component, Fe component, and M component” refers to an alloy containing an R component, an Fe component, and an M component as main components (that is, the total of the R component, the Fe component, and the M component accounts for 50 atom % or more of the alloy), but Fe atom of the Fe component may be substituted with an atom of Co or Ni. In the present application, this alloy is also referred to as “a rare earth-iron-M-based alloy”, “a raw material alloy”, or “a mother alloy”. In addition, the “rare earth-iron-M-based alloy” is also referred to as an “R—Fe-M-based alloy”.

### (1) Step of Preparing Mother Alloy

The method illustrated as a method for preparing the R—Fe-M-based alloy are as follows: (I) a high frequency melting method in which each metal component of the R component, the Fe component, and the M component is melted by high frequency and casted into a mold or the like; (II) an arc melting method (which is also referred to as an arc button method) in which a metal component is charged into a boat of copper or the like and melted by arc discharge; (III) a drop casting method or a suction casting method in which a molten metal melted by arc melting is dropped at once into a mold cooled with water and rapidly cooled; (IV) a rapid quenching method in which a molten metal melted by high frequency melting is dropped onto a rotating copper roll to obtain a ribbon-shaped alloy; (V) a gas atomization method in which a molten metal melted by high frequency is sprayed with gas to obtain an alloy powder; (VI) a R/D method of reacting Fe component and/or M component powder or Fe-M alloy powder, R and/or M component oxide powder, and a reducing agent at a high temperature to diffuse the R component or the R component and the M component into the Fe component and/or the Fe-M alloy powder while reducing the R component or the R component and the M component; (VII) a mechanical alloying method in which individual metal components and/or alloys are reacted while being finely pulverized by using a ball mill; and (VIII) an HDDR (i.e., Hydrogenation Decomposition Desorption Recombination) method in which the alloy obtained by any of the above methods is heated in a hydrogen atmosphere, decomposed into the following: a hydride of an R component and/or an M component; and an Fe component and/or an M component or an Fe-M alloy, and then recombined and alloyed while expelled hydrogen under high temperature and low pressure, and may be used any of the above methods.

In the case of using the high frequency melting method or the arc melting method, the component of which a main component is Fe is likely to precipitate when the alloy is solidified from the molten state, and the volume fraction of the component having the maximum absorption frequency in the low frequency region increases, particularly even after the nitriding step, thereby causing a decrease in absorption at high frequencies and in the ultra-high frequency region. Therefore, for the purpose of making the component of which a main component is Fe disappeared or increasing the crystal structure of tetragonal, rhombohedral, or hexagonal crystal (in particular, tetragonal crystal), it is effective to perform annealing in a temperature range of 200° C. or more and 1300° C. or less, preferably in a range of 600° C. or more and 1185° C. or less, in a gas containing at least one of an inert gas such as argon or helium, or a hydrogen gas, or in vacuum. The alloy produced according to this method has a large crystal particle diameter, good crystallinity, and high permeability compared with the case of using a rapid quenching method or the like. Therefore, this alloy contains a large amount of a homogeneous main raw material phase, and is preferable as a mother alloy to obtain the magnetic material of the present invention. On the other hand, the mother alloy obtained by the rapid quenching method or the mechanical alloying method is excellent in that the mother alloy can be homogenized by short-time annealing because the mother alloy has a fine metal structure. As an alloy production method utilizing these advantages, there are a suction casting method and a drop casting method. The melting method of the alloy is equivalent to arc melting, but since the cooling speed is faster than the normal arc button method, the phase separation state is fine, and the annealing time is generally short.

### (2) Coarsely Pulverizing and Classifying Steps

The alloy ingot, the R/D method or the HDDR method alloy powder prepared according to the above method can also be directly nitrided, but if the crystal particle diameter is larger than 2000 μm, the nitriding treatment time becomes longer, and thus it is more efficient to perform the nitriding step after coarse pulverization. The coarse pulverization to 200 μm or less is particularly preferable because the nitriding efficiency is further improved.

In the coarsely pulverizing step, the coarse pulverization is performed by using a jaw crusher, a hammer, a stamp mill, a rotor mill, a pin mill, a cutter mill, or the like. In addition, even when a pulverizer such as a ball mill or a jet mill is used, an alloy powder suitable for performing the nitriding step can be prepared depending on conditions. A method of causing hydrogen to be absorbed by the mother alloy to absorb and then pulverizing the alloy with the above pulverizer, or a method of pulverizing after repeating the absorption and release of hydrogen in the alloy may be used.

Furthermore, in the classifying step, it is also effective to perform particle diameter adjustment by using a classifier such as a sieve, a vibration type or a sound type classifier, an air sieve, or a cyclone after coarse pulverization in order to perform more uniform nitridization. When annealing is performed in an inert gas or hydrogen after coarse pulverization and classification, structural defects can be removed, which is effective in some cases. As described above, the preparation method of the powder raw material or the ingot raw material of the R—Fe-M-based alloy in the production method of the present invention has been exemplified, but there is a difference in the optimum conditions of the nitriding step, as shown below depending on the crystal particle diameter, the pulverized particle diameter, the surface state, and the like of these raw materials.

### (3) Nitriding and Annealing Steps

The nitriding step is a step of bringing a gas containing a nitrogen source, such as an ammonia gas or a nitrogen gas, into contact with the R—Fe-M-based alloy powder or ingot obtained in the step of (1) (i.e., “Step of preparing mother alloy”) or the steps of (1) (i.e., “Step of preparing mother alloy”) and (2) (i.e., “Coarsely pulverizing and classifying steps”) to introduce nitrogen into the crystal structure.

At this time, it is preferable that hydrogen coexists in the nitriding atmosphere gas from the viewpoint that nitriding efficiency is high and nitriding step can be performed while the crystal structure is stable. In order to control the reaction, an inert gas such as argon, helium, or neon can occasionally coexist. The most preferable nitriding atmosphere is a mixed gas of ammonia and hydrogen, and when the total pressure of ammonia and hydrogen is around normal pressure (1 atm), particularly when the partial pressure of ammonia is in the range of 0.1 atm or more and 0.7 atm or less and the total pressure of ammonia and hydrogen is outside normal pressure, if the molar fraction of ammonia is controlled in the range of 0.1 or more and 0.7 or less, a magnetic material having highly nitriding efficiency and covering the entire nitrogen amount range of the rare earth-iron-M-nitrogen-based magnetic material (specifically, the magnetic material is represented by a general formula of RₓFe_{(100-x-y-z)}M_{y}N_{z}, wherein the R is at least one element selected from Y, Ce, Pr, Nd, Gd, Tb, Dy, Ho, Er, Tm, Lu, and Sm, the Fe is an iron element, the M is at least one element selected from the group consisting of Ti, V, Mo, Nb, W, Si, Al, Mn, and Cr, the N is a nitrogen element, each value of the x, y, and z satisfies 2 atom %≤x≤15 atom %, 0.5≤y≤25 atom %, and 3≤z≤50 atom %) used in the present invention can be produced.

The nitriding reaction can be controlled by gas composition, heating temperature, heat treatment time, and applied pressure. Among them, the heating temperature varies depending on the mother alloy composition and the nitriding atmosphere, but is desirably selected in the range of 100° C. or more and 600° C. or less. Setting the heating temperature to 100° C. or higher is preferable in terms of avoiding the problem that the nitriding speed is very slow when the temperature is lower than the above value, and setting the heating temperature to 600° C. or lower is more preferable in terms of avoiding the following problem: since the main raw material phase is decomposed into the nitrides of the rare earth nitride, the iron nitride, and the M component when the temperature is higher than the above value, the nitriding treatment cannot be performed while maintaining at least one crystal structure selected from tetragonal, hexagonal, rhombohedral crystal, and amorphous state (in particular, tetragonal crystal or amorphous state). In order to increase the nitriding efficiency and the content of the main phase, a more preferable temperature range is 250° C. or more and 500° C. or less. When a rare earth-iron-M-nitrogen-based magnetic material of tetragonal system is prepared with the nitriding treatment, a temperature range of 100° C. or more and 500° C. or less is suitable in an ammonia-hydrogen atmosphere, and regardless of the crystal structure of the raw material alloy, when an amorphous rare earth-iron-M-nitrogen-based magnetic material is prepared with the nitriding and amorphizing treatment, a temperature range of 250° C. or more and 600° C. or less is suitable in an ammonia-hydrogen atmosphere. In particular, when an amorphous rare earth-iron-M-nitrogen-based magnetic material is produced by nitriding and amorphizing a tetragonal raw material alloy, a temperature range of 250° C. or higher and 500° C. or lower is preferable.

In addition, annealing in an inert gas and/or a hydrogen gas after nitriding is preferable from the viewpoint of improving magnetic properties. In particular, producing an R—Fe-M-N-based magnetic material in a highly nitrided region in which the amount of nitrogen is 7 atom % or more and 30 atom % or less and then performing annealing in an atmosphere containing hydrogen gas is a very preferable method from the viewpoint of increasing the permeability and magnetization by improving the crystallinity and homogeneity of the nitrogen-containing magnetic material.

Examples of the nitriding and annealing apparatus include a horizontal and vertical tubular furnace, a rotary reaction furnace, and a sealed reaction furnace. Even using any apparatus, the magnetic material of the present invention can be adjusted, but in particular, it is preferable to use a rotary reaction furnace in order to obtain a powder having a uniform nitrogen composition distribution.

The gas used in the reaction is supplied according to an air flow method of sending an air flow of 1 atm or more into the reaction furnace while keeping the gas composition constant, a sealing method of sealing the gas in a region of an applied pressure of 0.01 atm or more and 70 atm or less in the vessel, or a combination thereof.

The R—Fe-M-N-based magnetic material is produced for the first time through the above steps, that is, the steps from the above (1) (i.e., “Step of preparing mother alloy”) to the “Nitriding and annealing steps” of the present step (3). When the present step (3) is performed by using a gas as a hydrogen source, an R—Fe-M-N—H-based magnetic material can also be prepared.

### (4) Finely Pulverizing Step

The finely pulverizing step is a step performed for the purpose of pulverizing the above R—Fe-M-N-based magnetic material or the above R—Fe-M-N—H-based magnetic material to a finer fine powder or introducing an O component and an H component into the R—Fe-M-N-based magnetic material in order to obtain the R—Fe-M-N—H—O-based magnetic material.

In the finely pulverizing step, as the method for fine pulverization, in addition to the method mentioned in the steps of the above (2) (i.e., “Coarsely pulverizing and classifying steps”), dry and wet fine pulverizers such as a rotating ball mill, a vibrating ball mill, a planetary ball mill, a wet mill, a jet mill, a cutter mill, a pin mill, and an automatic mortar, and combinations thereof are used. When the O component and the H component are introduced, examples of the method for adjusting the introduction amount to the range of the present invention include a method for controlling the amount of moisture and the oxygen concentration in the finely pulverizing atmosphere.

The preferred method for producing the rare earth-iron-M-nitrogen-based magnetic material of the present invention is one using the steps of: preparing a mother alloy of R—Fe-M component composition according to the methods exemplified in the step of (1) (i.e., “Step of preparing mother alloy”) or the step of (1) (i.e., “Step of preparing mother alloy”) and the steps of (2) (i.e., “Coarsely pulverizing and classifying steps”); nitriding the mother alloy according to the method exemplified in the step of (3) (i.e., “Nitriding and annealing steps”); and then finely pulverizing the nitride as shown in the step of (4) (i.e., “Finely pulverizing step”). In particular, when a raw material alloy obtained in the step of (1) (i.e., “Step of preparing mother alloy”) or a raw material alloy obtained by pulverizing and classifying it according to the method shown in the step of (2) (i.e., “Coarsely pulverizing and classifying steps”) is annealed by performing the heat treatment at 600° C. or more and 1300° C. or less in an atmosphere containing at least one of an inert gas and a hydrogen gas, and then is nitrided, a magnetic material having extremely small deterioration in magnetic properties due to in-powder oxidation can be obtained.

### (5) Ceramic Material Mixing Step

This step is a step of mixing the rare earth-iron-M-nitrogen-based magnetic material obtained in the step of (3) (i.e., “Nitriding and annealing steps”) or the step of (4) (i.e., “Finely pulverizing step”) with a ceramic material. An ordinary mixer such as a V-type mixer, a tumbler, a vibration mixer, a shaker, a drum mixer, a rocking mixer, a shaker, and a rotary mixer, or the above pulverizer or classifier can be used. This step, that is, the step of (5) can also be performed simultaneously with the steps of (1) to (3) above. In the present invention, when a nanoceramic powder is used as the ceramic material, not only mixing becomes efficient but also electromagnetic properties are improved.

### (6) Orientation and Molding Step

The high-frequency magnetic material of the present invention can be used in various uses, for example, by blending (i.e., mixing) a predetermined rare earth-iron-M-nitrogen-based magnetic material with another magnetic material, a ceramic material, and/or a resin and molding the mixture. In particular, when the resin described above is blended, the high-frequency resin composite magnetic material of the present invention is obtained. In addition, when the high-frequency magnetic material of the present invention is an anisotropic material, if the magnetic field orientation operation is performed at least once in this molding step, a magnetic material or a resin composite magnetic material having high magnetic properties is obtained, and thus the magnetic field orientation operation is particularly recommended.

As a method for solidifying the high-frequency composite magnetic material of the present invention obtained by, for example, blending (mixing) a predetermined rare earth-iron-M-nitrogen-based magnetic material with another magnetic material, a ceramic material, and/or a resin, there is also a method in which the high-frequency composite magnetic material is placed in a mold, compacted in a cold state, and used as it is, or molded by subsequently performing cold rolling, forging, shock wave compression molding, or the like. In many cases, the high-frequency composite magnetic material may be molded by sintering while performing the heat treatment at a temperature of 50° C. or higher. The heat treatment atmosphere is preferably a non-oxidizing atmosphere, and for example, the heat treatment may be performed in an inert gas such as a rare gas such as argon or helium or a nitrogen gas, or in a reducing gas containing a hydrogen gas. Even in the atmosphere, the heat treatment can be performed if the temperature condition is 500° C. or less. In addition, sintering under normal pressure or pressure, or sintering in vacuum may be performed.

The above heat treatment can be performed simultaneously with the powder compaction-molded, and the magnetic material of the present invention can also be molded by a pressure sintering method such as a hot press method, a hot isostatic press (HIP) method, or a spark plasma sintering (SPS) method. In order to remarkably obtain the pressurizing effect on the present invention remarkable, the applied pressure in the thermal sintering step is preferably in the range of 0.0001 GPa or more and 10 GPa or less. When the applied pressure is less than that, the pressurization effect is poor, and there is no difference in electromagnetic properties from normal pressure sintering. Therefore, setting the applied pressure to 0.0001 GPa or more is preferable in terms of avoiding occurrence of a disadvantage due to decrease in productivity when pressure sintering is performed. In addition, setting the applied pressure to 10 GPa or less is preferable in terms of avoiding the following problem: the pressurization effect is saturated when the pressure exceeds the above value, and thus even if the pressure is further increased, the productivity is merely lowered.

In addition, large pressurization imparts induced magnetic anisotropy to the magnetic material, and thus there is a possibility that magnetic properties that is inherently provided, for example, high permeability deteriorate or the maximum absorption frequency deviates from a preferable range. Therefore, the preferable range of the applied pressure is 0.001 GPa or more and 1 GPa or less, and more preferably 0.01 GPa or more and 0.1 GPa or less.

Furthermore, for most of the above methods, the magnetic material may be solidified with some decomposition of the surface of the magnetic material, but among the shock wave compression methods, a known underwater shock wave compression method is advantageous as a method capable of molding without decomposition of the magnetic material.

In the case of applying to a high-frequency resin composite magnetic material the powder of the rare earth-iron-M-nitrogen-based magnetic material and/or the powder of the composite magnetic material obtained in the following step(s): “the step of (3) above (i.e., “Nitriding and annealing steps”)”; “the step of (3) above (i.e., “Nitriding and annealing steps”)→the step of (4) above (i.e., “Finely pulverizing step”)”; “the step of (3) above (i.e., “Nitriding and annealing steps”)→the step of (5) above (i.e., “Ceramic material mixing step”)”; or “the step of (3) above (i.e., “Nitriding and annealing steps”)→the step of (4) above (i.e., “Finely pulverizing step”)→the step of (5) above (i.e., “Ceramic material mixing step”)”, the powder of the rare earth-iron-M-nitrogen-based magnetic material and/or the powder of the composite magnetic material obtained in the above step(s) are mixed with a thermosetting resin or a thermoplastic resin and then compression-molded, kneaded together with a thermoplastic resin and then injection-molded, or further subjected to extrusion molding, roll molding, and/or calendering molding as necessary. In the above mixing, a casting method is also effective in which a resin dissolved in a solvent is blended in a magnetic powder and then the solvent is removed by vaporization or the like. As for the kneading, it is also effective to use a kneader or a uniaxial or biaxial extruder.

For example, when the sheet is applied to an electromagnetic noise absorbing sheet, examples of the kind of the shape of the sheet include a batch-type sheet obtained by compression molding having a thickness of 5 μm or more and 10,000 μm or less, a width of 5 mm or more and 5000 mm or less, and a length of 0.005 m or more and 1000 m or less, and a roll-shaped sheet obtained by roll molding, calendering molding, or the like.

When molding is performed by the above method, if a part or all of the step is performed in a magnetic field, the magnetic particles may be magnetically oriented to improve magnetic properties. The magnetic field orientation method includes three major kinds: uniaxial magnetic field orientation, rotating magnetic field orientation, and opposing magnetic pole orientation.

The uniaxial magnetic field orientation means that a magnetic material or a composite magnetic material in a movable state is usually applied with a static magnetic field in an arbitrary direction from the outside to align an easy magnetization direction of the magnetic material with an external static magnetic field direction. Thereafter, usually, a pressure is applied or the resin component is solidified to prepare a uniaxial magnetic field orientation molded body.

The rotating magnetic field orientation is a method in which a magnetic material or a composite magnetic material in a movable state is placed in an external magnetic field that usually rotates in one plane, and the magnetization difficult direction of the magnetic material is aligned in one direction. Examples of the method of rotating include a method of rotating an external magnetic field; a method of rotating a magnetic material in a static magnetic field; a method in which neither an external magnetic field nor a magnetic material is rotated, but the strengths of a plurality of magnetic poles are synchronized and changed, and a magnetic field is applied as needed in a sequence in which the magnetic material feels as if the magnetic field is rotating; and a combination of the above methods. In extrusion molding, roll molding, or the like, a method in which two or more magnetic poles are arranged in the extrusion direction, the strength or polarity of the magnetic field is changed, and the magnetic field is arranged and oriented so as to feel a rotating magnetic field when the composite magnetic material or the resin composite magnetic material passes is also a rotating magnetic field orientation in a broad sense.

The counter magnetic pole orientation is a method in which a magnetic material or a composite magnetic material is allowed to stand in an environment in which magnetic poles of the same pole face each other, or is moved by a rotational or translational motion, or a combination thereof to align a magnetization difficult direction in one direction.

When a magnetic material or a composite magnetic material having in-plane magnetic anisotropy is subjected to uniaxial magnetic field orientation, the permeability is improved in a range of 1% or more and 50% or less, and when rotating magnetic field orientation or opposed magnetic pole orientation is performed, the permeability is improved in a range of 1% or more and 200% or less.

The magnetic field molding is performed in a magnetic field of preferably 8 kA/m or more, more preferably 80 kA/m or more, and most preferably 400 kA/m or more in order that the magnetic material is sufficiently magnetically orient. The strength and time of the magnetic field required for magnetic field orientation are determined by the shape of the magnetic material powder, the viscosity of the matrix in the case of the resin composite magnetic material, and the affinity with the magnetic material powder.

In general, since the use of a stronger magnetic field shortens the orientation time, it is desirable to use a magnetic field of 400 kA/m or more for the magnetic field orientation in roll molding or calendering molding in which the molding time is short and the viscosity of the matrix resin is high.

### EXAMPLES

Hereinafter, the present invention is described more specifically with reference to Examples and the like, but the present invention is not limited by these Examples and the like at all. For example, the present invention discloses in detail electromagnetic properties in a range of 0.001 GHz or more and 3 GHz or less according to Examples, and demonstrates that the magnetic material of the present invention has an excellent “target function”, but the material of the present invention is not used only in the range.

### Examples 1 and 2, and Comparative Example 1

The ingot prepared by the suction casting method was annealed at 1000° C. for 2 hours to prepare a raw material alloy having a composition of Sm_{7.7}Fe_{84.6}Ti_{7.7} as a raw material of a rare earth-iron-M-based alloy.

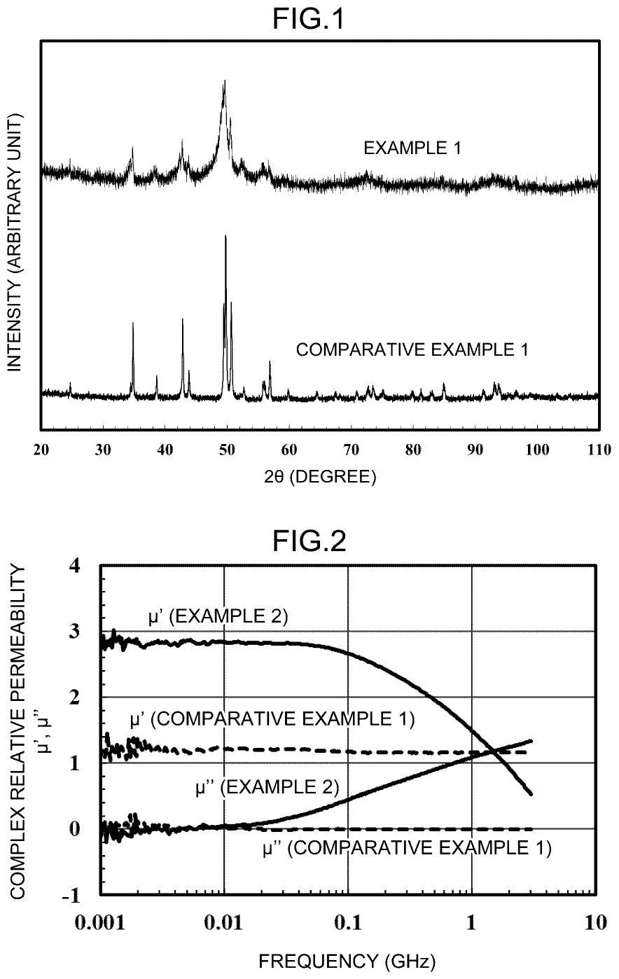

This raw material alloy was further pulverized with a cutter mill in an argon atmosphere to obtain a Sm_{7.7}Fe_{84.6}Ti_{7.7} raw material alloy powder (Comparative Example 1) having an average particle diameter of about 60 μm. The raw material alloy powder was charged into a horizontal tube furnace and heat-treated at 390° C. for 30 minutes in a mixed air flow having an ammonia partial pressure of 0.33 atm and a hydrogen gas partial pressure of 0.67 atm to prepare a magnetic powder having a composition of Sm_{6.4}Fe_{70.5}Ti_{6.4}N_{16.7} (i.e., “Example 1”). As a result of analyzing the magnetic material of this powder by an X-ray diffraction method (Co-Kα radiation source), diffraction line showing tetragonal crystal was observed as shown in FIG. 1. The X-ray diffraction diagram of the raw material alloy before nitriding (i.e., “Comparative Example 1”) was also shown in FIG. 1, but diffraction line showing tetragonal crystal was observed as in Example 1. However, it has been found that each diffraction line is shifted to a low angle by the nitriding treatment, and the tetragonal system crystal lattice having the ThMn₂ structure was expanded by nitrogen entering between lattices, and the lattice volume was increased.

The rare earth-iron-M-nitrogen-based magnetic material (specifically, a magnetic material having a composition of Sm_{6.4}Fe_{70.5}Ti_{6.4}N_{16.7}) of the powder of Example 1 had a magnetization value of 112 emu/g and a magnetic anisotropic magnetic field of 4.32 T. The magnetic material was an in-plane magnetic anisotropic material.

From this result, it has been found that the rare earth-iron-M-nitrogen-based magnetic material obtained in Example 1 can be used as a high-frequency magnetic material.

Subsequently, the rare earth-iron-M-nitrogen-based magnetic material powder (specifically, a powder of the magnetic material having a composition of Sm_{6.4}Fe_{70.5}Ti_{6.4}N_{16.7} in Example 1) obtained above was finely pulverized with a ball mill for 4 hours to prepare a Sm—Fe—Ti—N-based magnetic material powder (i.e., “Example 2”) having an average particle diameter of about 4 μm. That was blended and kneaded with 8% by mass of an epoxy resin having a solubility parameter value of 11, and cured at 50° C. for 1 day and night to prepare a toroidal resin composite magnetic material having an inner diameter of 3.1 mm, an outer diameter of 8 mm, and a thickness of 1 mm. The density of the prepared resin composite magnetic material was 4.9 g/cm₃, and the volume fraction of the magnetic material was 62 vol %.

The frequency change of the complex relative permeability (μᵣ) of the resin composite magnetic material using the rare earth-iron-M-nitrogen-based magnetic powder (specifically, a powder obtained by finely pulverizing the Sm_{6.4}Fe_{70.5}Ti_{6.4}N_{16.7} magnetic powder of “Example 1” with a ball mill) of Example 2 is shown in FIG. 2. From FIG. 2, it has been confirmed that the value of the real term (μ′) of the complex relative permeability (μᵣ) in the range of 0.001 GHz or more and 0.1 GHz or less is substantially constant in the range of 2.9 to 2.7, the value of the imaginary term (μ″) of the complex relative permeability (μᵣ) is as small as 0 to 0.6, and the material can be used as a high frequency amplifying material in this region. In addition, the values of the real term (μ′) and the imaginary term (μ″) of the complex relative permeability (μᵣ) at 3 GHz were 1.3 and 0.4, respectively, and the maximum absorbed energy coefficient at that frequency reached 13 GHz. Therefore, it has been found that the high-frequency composite magnetic material is suitable as an electromagnetic noise absorbing material in an ultra-high frequency region per 3 GHz. Furthermore, by extrapolating the frequency change of the complex relative permeability in FIG. 2 to the high frequency side, it has been found that the electromagnetic noise absorbing material is suitable even at 3 GHz or more.

In addition, the volume resistivity of this toroidal was 10⁷ Ωcm, and it has been found that the material is a resin composite magnetic material having extremely good insulation properties and excellent isolated dispersibility, and is a suitable high-frequency resin composite magnetic material.

FIG. 1 also shows the results of measuring the frequency change of the complex relative permeability (μᵣ) using the raw material alloy powder having the composition of Sm_{7.7}Fe_{84.6}Ti_{7.7} before the nitriding treatment (i.e., “Comparative Example 1”) as a toroidal sample (density: 4.9 g/cm³, volume fraction of magnetic powder: 58 vol %) in the same manner as in “Example 2”. The value of the real term (μ′) of the complex relative permeability (μᵣ) in the range of 0.001 GHz or more and 0.1 GHz or less is substantially constant at 1.2, and the imaginary term (μ″) is substantially constant at 0. It has been found that the magnetic material is not suitable as a high-frequency magnetic material because the magnetic material exhibits a permeability change peculiar to a uniaxial magnetic anisotropic material without being largely different from the permeability of vacuum, and in a frequency region from 0.001 GHz to 3 GHz, the magnetic field is hardly amplified (μ′ times) and electromagnetic noise is not absorbed (the amount of absorbed energy is proportional to μ″). Incidentally, it has been found that the magnetic material of “Comparative Example 1” exhibited uniaxial magnetic anisotropy by the magnetic field orientation experiment, but in “Example 2”, when considered in conjunction with the results of the X-ray diffraction method, it has been found that the magnetic anisotropy is dramatically changed from uniaxial to in-plane due to entry of nitrogen between lattices of the tetragonal crystal structure, and the high frequency properties is also dramatically improved.

As described above, it has been found that the rare earth-iron-M-nitrogen-based resin composite magnetic material obtained in “Example 2” can be used as a high-frequency magnetic material.

### Example 3

A Sm_{7.2}Fe_{72.4}V_{14.5}N_{5.9} based magnetic material powder (“Example 3”) having an average particle diameter of about 60 μm was prepared in the same manner as in “Example 1”. The rare earth-iron-M-nitrogen-based magnetic material (specifically, the Sm_{7.2}Fe_{72.4}V_{14.5}N_{5.9} based magnetic material of the powder of “Example 3”) of this powder had a magnetization value of 132 emu/g and a magnetic anisotropic magnetic field of 7.25 T. The magnetic material was an in-plane magnetic anisotropic material. The powder is not finely pulverized. The above powder was blended and kneaded with 8% by mass of an epoxy resin having a solubility parameter value of 11, and cured at 50° C. for 1 day and night to prepare a toroidal resin composite magnetic material having an inner diameter of 3.1 mm, an outer diameter of 8 mm, and a thickness of 1 mm. The density of the prepared resin composite magnetic material was 5.0 g/cm³, and the volume fraction of the magnetic material was 61 vol %.

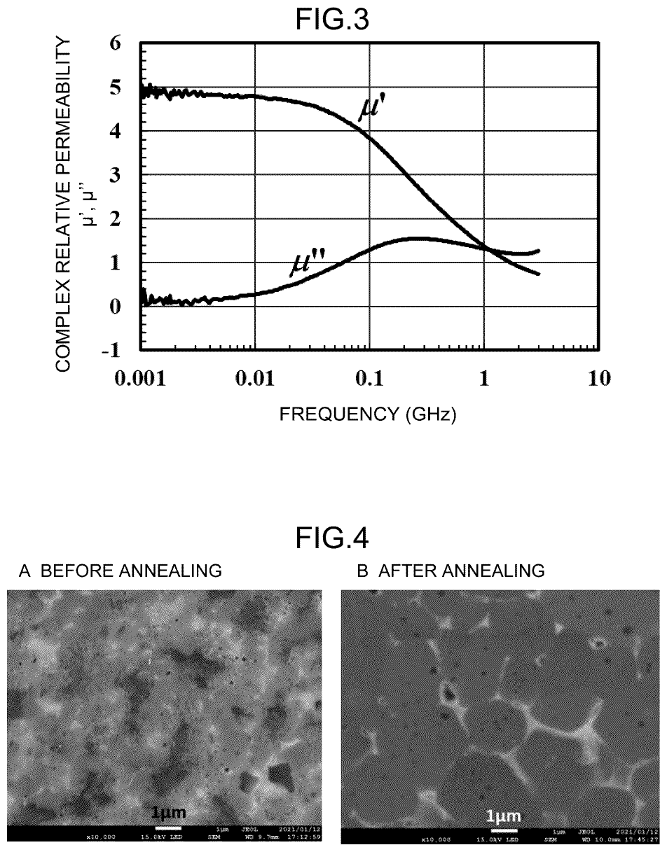

The frequency change of the complex relative permeability (μᵣ) of the rare earth-iron-M-nitrogen-based resin composite magnetic material obtained in this example is as shown in FIG. 3, the value of the real term (μ′) of the complex relative permeability (μᵣ) in the range of 0.001 GHz to 0.1 GHz is substantially constant from 5.0 to 3.8, and the value of the imaginary term (μ″) of the complex relative permeability (μᵣ) is as small as 0 to 1.4, and it has been found that the rare earth-iron-M-nitrogen-based resin composite magnetic material can be used as a high frequency amplifying material in this region.

Also, the maximum absorbed energy coefficient was 3.9 GHz at a frequency of 3 GHz. Therefore, it has been found that the material is a high-frequency composite magnetic material suitable as an electromagnetic noise absorbing material in an ultra-high frequency region per 3 GHz, and further, it has been found that the material is suitable as an electromagnetic noise absorbing material even at 3 GHz or more by extrapolating the frequency change of the complex relative permeability in FIG. 3 to the high frequency side.

As described above, it has been found that the rare earth-iron-M-nitrogen-based resin composite magnetic material obtained in “Example 3” can be used as a high-frequency magnetic material.

### Example 4 and Comparative Example 2

The ingot prepared by the suction casting method was annealed at 1000° C. for 2 hours to prepare a raw material alloy having a composition of Ce_{7.7}Fe_{84.6}Ti_{7.7} as a raw material of a rare earth-iron-M-based alloy. SEM (scanning electron microscope) photographs of the cross section of the raw material alloy before and after annealing are shown in FIG. 4. Since the suction casting method was used, the phase separation immediately after casting (FIG. 4A, before annealing) was small, and a homogeneous raw material alloy (FIG. 4B, after annealing) could be prepared by annealing at 1000° C. for 2 hours. In FIG. 4, it has been found that a black region is a Fe—Ti alloy phase having a bcc structure having a cubic crystal structure, a gray region is a CeFe₁₁Ti alloy phase having a ThMn₁₂ structure having a tetragonal crystal structure, and a white region is a Ce-enriched phase such as a Ce₂Fe₁₇ alloy phase having a Th₂Zn₁₇ structure having a rhombohedral crystal structure, by analysis using SEM-EDX or the like in combination.

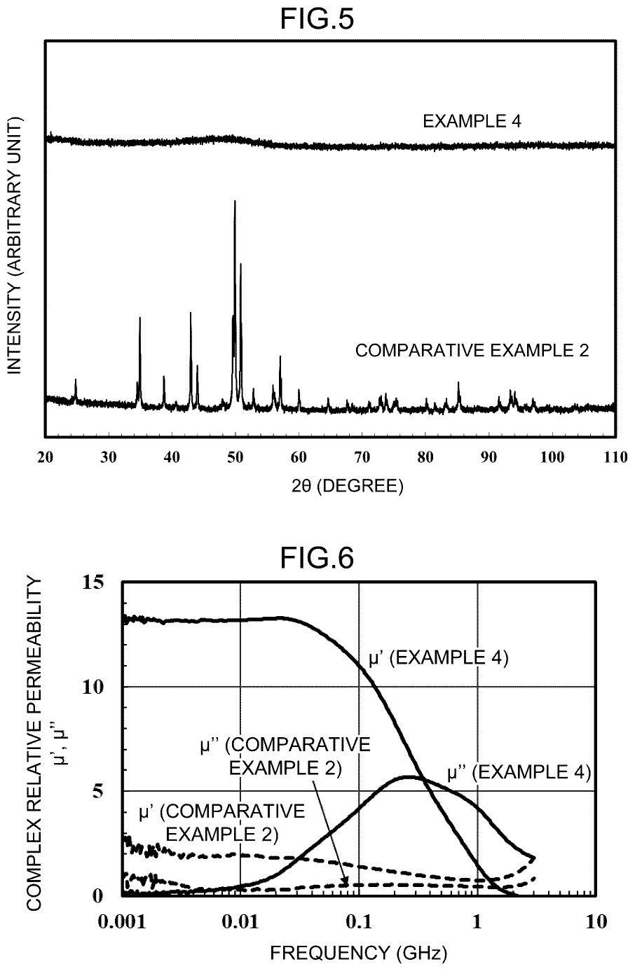

The raw material alloy was pulverized with a cutter mill in an argon atmosphere to obtain a Ce_{7.7}Fe_{84.6}Ti_{7.7} raw material alloy powder (i.e., “Comparative Example 2”) having an average particle diameter of 60 μm. The raw material alloy powder was charged into a horizontal tube furnace and heat-treated at 390° C. for 30 minutes in a mixed air flow having an ammonia partial pressure of 0.33 atm and a hydrogen gas partial pressure of 0.67 atm to prepare a magnetic powder (i.e., “Example 4”) having a composition of Ce_{5.3}Fe_{55.2}Ti_{5.3}N_{31.2} and an average particle diameter of 40 μm. The rare earth-iron-M-nitrogen-based magnetic material (specifically, a magnetic material having a composition of Ce_{5.3}Fe_{55.2}Ti_{5.3}N_{31.2}) of the powder of Example 4 had a magnetization value of 104 emu/g, and was a magnetically isotropic material. The results of analyzing the magnetic powders of “Comparative Example 2” and “Example 4” by X-ray diffraction (Co-Kα radiation source) are shown in FIG. 5. From the figure, it has been found that the raw material powder of the Comparative Example has a crystal structure of tetragonal system. In addition, it has become clear that the magnetic powder of “Example 4” has become to be homogeneous amorphous state due to collapse of the crystal structure of a tetragonal system of the raw material due to the nitriding and amorphizing treatment.

From this result, it has been found that the rare earth-iron-M-nitrogen-based magnetic material obtained in “Example 4” can be used as the high-frequency magnetic material of the present invention.

Subsequently, the above rare earth-iron-M-nitrogen-based magnetic material was blended and kneaded with 8% by mass of an epoxy resin having a solubility parameter value of 11, and cured at 50° C. for 1 day and night to prepare a toroidal resin composite magnetic material having an inner diameter of 3.1 mm, an outer diameter of 8 mm, and a thickness of 1 mm. The density of the prepared resin composite magnetic material was 5.4 g/cm³, and the volume fraction of the magnetic material was 66 vol %.

The frequency change of the complex relative permeability (μᵣ) of the rare earth-iron-M-nitrogen-based resin composite magnetic material obtained in the Example is shown in FIG. 6. The value of the real term (μ′) of the complex relative permeability (μᵣ) in the range of 0.001 GHz or more and 0.03 GHz or less was an extremely high value of 13.2. The value of the imaginary term (μ″) of the complex relative permeability (μᵣ) was almost 0 at around 0.001 GHz to 0.005 GHz. Therefore, it has been found that the material can be used as a magnetic field amplifying material in this region. In addition, the value of the complex relative permeability (μᵣ) at 0.3 GHz was 5.7, and thus it has been found that the material can be used as an electromagnetic noise absorbing material in this region.

A raw material alloy of Ce_{7.7}Fe_{84.6}Ti_{7.7} composition before nitriding (i.e., “Comparative Example 2”) was prepared as a toroidal sample (density: 5.0 g/cm³, volume fraction of magnetic powder: 59 vol %) in the same manner as in “Example 4”. The frequency change of the complex relative permeability (μᵣ) is also shown in FIG. 6. The value of the real term (μ′) of the complex relative permeability (μᵣ) of Comparative Example 1 at 0.001 GHz to 0.03 GHz was approximately in the range of 2.8 to 1.9, which was lower than that of “Example 4”. Furthermore, the imaginary term (μ″) of the complex relative permeability (μᵣ) of “Comparative Example 1” in the frequency region of 0.001 to 0.003 GHz was in the range of 1 to 0.5, and it has been found that the loss was large for use the magnetic field amplifying material compared with “Example 4”, and the material cannot be used as a high frequency amplifying material.

As described above, it has been found that the rare earth-iron-M-nitrogen-based resin composite magnetic material obtained in “Example 4” can also be used as a high-frequency magnetic material.

### Example 5

In a rare earth-iron-M alloy material, Nd, Sm, and Ce were selected as rare earth elements, and Ti, Mo, Nb, Si, and Mn were selected as the M elements, and alloy preparation was performed in the same manner as in “Example 4”, and then nitriding was performed to prepare a rare earth-iron-M-nitrogen-based magnetic material in which a tetragonal phase having a ThMn₁₂ structure was a main phase. Further, the mixture was kneaded with a resin in the same manner as in “Example 4” to prepare a toroidal sample. The complex relative permeability (μᵣ) was measured in the same frequency region as in “Examples 2 to 4”, and data from 0.001 GHz to 0.1 GHz showing characteristic changes were extracted and marshaled as shown in Table 1. The values of the real terms (μ′) of the complex relative permeability (μᵣ) were all 2.6 or more, thereby indicating high values. In addition, it has been found that the imaginary term (μ″) of the complex relative permeability (μᵣ) can show a value close to 0 in the frequency region lower than 1 GHz for the materials of all Examples, and can also show a suitable value in the range of 0 to 2.0 for most materials, and can be used as a high frequency amplifying material in the region in all the Examples. In addition, in the Ce—Fe—Nb—N material, since the imaginary term (μ″) exceeds 3.0 in a high frequency region of 0.1 GHz or more, it has been found to be suitable as an electromagnetic noise absorber.

As described above, it has been found that the rare earth-iron-M-nitrogen-based magnetic material obtained in “Example 5” can be used as a high-frequency magnetic material.

TABLE 1

| | | | | | Relative | | | | |
|---|---|---|---|---|---|---|---|---|---|
| | Composition | | | | permeability | | | | |
| | Rare | | | | μ′ | μ″ | High | | |
| | earth | Fe | M | Nitrogen | (0.001- | (0.001- | frequency | | |
| | (at %) | (at %) | (at %) | (at %) | 0.1 GHz) | 0.1 GHz) | properties | State | Remarks |
| SmFeTiN | 6.4 | 70.5 | 6.4 | 16.7 | 2.9~2.7 | 0~0.5 | Good | In-plane | Examples |
| | | | | | | | | anisotropy | 1, 2 |
| SmFeTi | 7.7 | 84.6 | 7.7 | 0.0 | 1.2 | 0 | Unacceptable | Uniaxial | Comparative |
| | | | | | | | | anisotropy | Example 1 |
| CeFeTiN | 5.3 | 58.2 | 5.3 | 31.2 | 13.2~11.0 | 0~4.1 | Good | Amorphous | Example 4 |
| | | | | | | | | state | |
| CeFeTi | 7.7 | 84.6 | 7.7 | 0.0 | 2.8~1.9 | 1~0.6 | Unacceptable | Uniaxial | Comparative |
| | | | | | | | | anisotropy | Example 2 |
| SmFeVN | 7.2 | 72.4 | 14.5 | 5.9 | 4.9~3.8 | 0~1.3 | Good | In-plane | Example 3 |
| | | | | | | | | anisotropy | |
| CeFeVN | 6.7 | 73.5 | 6.7 | 13.1 | 4.5~3.5 | 0~1.0 | Good | In-plane | Example 5 |
| | | | | | | | | anisotropy | |
| SmFeMoN | 6.8 | 74.8 | 6.8 | 11.6 | 6.0~4.2 | 0~1.9 | Good | In-plane | Example 5 |
| | | | | | | | | anisotropy | |
| CeFeMoN | 5.8 | 63.9 | 5.8 | 24.5 | 5.1~4.9 | 0~0.9 | Good | In-plane | Example 5 |
| | | | | | | | | anisotropy | |
| SmFeNbN | 7.3 | 80.4 | 7.3 | 4.9 | 4.2~2.6 | 0~1.5 | Good | In-plane | Example 5 |
| | | | | | | | | anisotropy | |
| CeFeNbN | 6.8 | 74.6 | 6.8 | 11.9 | 7.8~5.0 | 0~3.0 | Good | In-plane | Example 5 |
| | | | | | | | | anisotropy | |
| SmFeSiN | 7.4 | 81.4 | 7.4 | 3.8 | 5.0~3.7 | 0~1.4 | Good | In-plane | Example 5 |
| | | | | | | | | anisotropy | |
| CeFeSiN | 7.2 | 79.7 | 7.2 | 5.8 | 7.5~6.0 | 0~1.8 | Good | In-plane | Example 5 |
| | | | | | | | | anisotropy | |
| SmFeMnN | 7.0 | 77.2 | 7.0 | 8.8 | 5.4~4.5 | 0~1.4 | Good | In-plane | Example 5 |
| | | | | | | | | anisotropy | |
| CeFeMnN | 6.7 | 74.1 | 6.7 | 12.4 | 7.6~7.0 | 0~1.3 | Good | In-plane | Example 5 |
| | | | | | | | | anisotropy | |

### INDUSTRIAL APPLICABILITY

The present invention relates to a high-frequency Composite magnetic material such as a magnetic material used in a transformer, a head, an inductor, a reactor, a yoke, a core (magnetic core), or the like, which is mainly used in a power device or an information communication-related device and is used in a high frequency region, an antenna, a microwave element, a magnetostrictive element, a magnetoacoustic element, a magnetic recording element, or the like, and sensors such as a Hall element, a magnetic sensor, a current sensor, a rotation sensor, or an electronic compass which transmits a magnetic field, in particular, a magnetic material that suppresses obstacles due to unnecessary electromagnetic interference such as a core of a coil or a core of an antenna used in a wireless power feeding (which is also referred to as wireless power transmission or contactless power transmission) system, or an electromagnetic noise absorbing material, an electromagnetic wave absorbing material, or a magnetic shielding material, or a magnetic material such as a material for an inductor element such as a noise removing inductor, a radio frequency identification (RFID) tag material, or a noise filter material, which removes noise from a signal in a high frequency region.

1. A high-frequency magnetic material, the magnetic material comprising: a main phase having a composition represented by a general formula represented by the following formula 1:
RₓFe_{(100-x-y-z)}M_{y}N_{z} (formula 1)
wherein the R is at least one element selected from the group consisting of rare earth elements including Y, the Fe is an iron element, the M is at least one element selected from the group consisting of Ti, V, Mo, Nb, W, Si, Al, Mn, and Cr, the N is a nitrogen element, and each value of the x, y, and z satisfies 2 atom %≤x≤15 atom %, 0.5 atom %≤y≤25 atom %, and 3 atom %≤z≤50 atom %, and
wherein the high-frequency magnetic material is used in a frequency region of 0.001 GHz or more and 100 GHz or less.

2. The high-frequency magnetic material according to claim 1, wherein Fe in the formula 1 is substituted with Co or Ni element in an amount of 50 atom % or less.

3. The high-frequency magnetic material according to claim 1, wherein R in the formula 1 contains Sm element in an amount of 50 atom % or more.

4. The high-frequency magnetic material according to claim 1, wherein a crystal structure of the main phase is a tetragonal.

5. The high-frequency magnetic material according to claim 1, wherein the magnetocrystalline anisotropy is in-plane magnetic anisotropy.

6. The high-frequency magnetic material according to claim 1, wherein a crystal structure of the main phase is amorphous.

7. The high-frequency magnetic material according to claim 1, wherein less than 50 atom % of N in the formula 1 is substituted with at least one element selected from the group consisting of H, C, P, Si, and S.

8. The high-frequency magnetic material according to claim 1, wherein the magnetic material is a powder having an average particle diameter of 0.1 μm or more and 2000 μm or less.

9. A high-frequency magnetic material comprising:
1% by mass or more and 99.999% by mass or less of the high-frequency magnetic material according to claim 1; and
0.001% by mass or more and 99% by mass or less of at least one selected from the group consisting of a metal Fe, a metal Ni, a metal Co, an Fe—Ni based alloy, an Fe—Ni—Si based alloy, a sendust, an Fe—Si—Al based alloy, an Fe—Cu—Nb—Si based alloy, an amorphous alloy, a magnetite, a Ni-ferrite, a Zn-ferrite, a Mn—Zn ferrite, and a Ni—Zn ferrite.

10. The high-frequency magnetic material according to claim 9, wherein the metal Fe is a carbonyl iron powder.

11. A high-frequency magnetic material comprising:
1% by mass or more and 99.999% by mass or less of the high-frequency magnetic material according to claim 1; and
0.001% by mass or more and 99% by mass or less of a ceramic material.

12. A high-frequency magnetic material comprising:
5% by mass or more and 99.9% by mass or less of the high-frequency magnetic material according to claim 1; and
0.1% by mass or more and 95% by mass or less of a resin.

13. The high-frequency magnetic material according to claim 12, wherein the resin comprises a segment having a solubility parameter of 10 or more and 15 or less.

14. The high-frequency magnetic material according to claim 1, wherein the high-frequency magnetic material is magnetically oriented.

15. A method for producing the high-frequency magnetic material according to claim 1, the method comprising heat-treating an alloy containing, as main components, R, Fe, and M in the formula 1 at a temperature in a range of 100° C. or more and 600° C. or less under a nitrogen atmosphere containing an ammonia gas.

16. A method for producing the high-frequency magnetic material according to claim 12, the method comprising the steps of: kneading the high-frequency magnetic material with a resin containing a segment having a solubility parameter of 10 or more and 15 or less; and performing a compression molding, an injection molding, and/or a calendering molding.
